(19) United States
(12) Patent Application Publication
(10) Pub. No.: US 2016/0219423 A1
(43) Pub. Date: Jul. 28, 2016

(54) METHOD FOR REMOTELY CONTROLLING ANOTHER DEVICE USING DIRECT COMMUNICATION AND APPARATUS THEREFOR

(71) Applicant: LG ELECTRONICS INC., Seoul (KR)

(72) Inventors: Byungjoo LEE, Seoul (KR); Wookbong LEE, Seoul (KR); Dongcheol KIM, Seoul (KR); Hangyu CHO, Seoul (KR)

(73) Assignee: LG ELECTRONICS INC., Seoul (KR)

(21) Appl. No.: 14/913,227

(22) PCT Filed: Aug. 20, 2014
(86) PCT No.: PCT/KR2014/007715

§ 371 Date: Feb. 19, 2016

Related U.S. Application Data
(60) Provisional application No. 61/868,056, filed on Aug. 20, 2013.
(60) Provisional application No. 61/885,534, filed on Oct. 2, 2013.

(51) Int. Cl. H04W 8/00; G08C 17/02

(52) U.S. Cl. CPC H04W 8/005; G08C 17/02; G08C 2201/30

(57) ABSTRACT

The present invention relates to a wireless communication system, and provides a method and apparatus for remotely controlling another device in a direct communication system. To this end, a method for performing a control service which can remotely control a second wireless device by a first wireless device may include the steps of: the first wireless device searching for the second wireless device; when the second wireless device is found, the first wireless device receiving command information supported by the second wireless device from the second wireless device; the first wireless device transmitting, to the second wireless device, command identification information for identifying a command to be processed by the second wireless device; and the first wireless device receiving a feedback on a processing result of the command from the second wireless device.

### TECHNICAL FIELD

Following description relates to a wireless communication system, and more particularly, to a method of remotely controlling another device in a direct communication system and an apparatus therefor.

### BACKGROUND ART

Recently, with the development of information communication technology, various wireless communication technologies have been developed. Of the technologies, wireless LAN (WLAN) is the technology that allows home or company or a specific service zone to access Internet wirelessly by using a portable terminal such as a personal digital assistant (PDA), a lap top computer, a portable multimedia player (PMP).

As direct communication technology that may allow devices to be easily connected with each other without a radio access point (AP) basically required in a conventional WLAN system, the introduction of Wi-Fi Direct or Wi-Fi peer-to-peer (P2P) has been discussed. According to Wi-Fi Direct, devices may be connected to each other even without a complicated establishment procedure. Also, Wi-Fi Direct may support a mutual operation for data transmission and reception at a communication speed of a general WLAN system to provide users with various services.

Recently, various Wi-Fi support devices have been used. Of the Wi-Fi support devices, the number of Wi-Fi Direct support devices that enable communication between Wi-Fi devices without AP has been increased. In Wi-Fi Alliance (WFA), technology for the introduction of a platform for supporting various services (for example, Send, Play, Display, Print, etc.) using Wi-Fi Direct link has been discussed. This may be referred to as Wi-Fi Direct Service (WFDS).

The present invention intends to define a new Wi-Fi Direct service capable of remotely controlling another device except four pre-defined services.

### DISCLOSURE OF THE INVENTION

### Technical Task

An object of the present invention is to provide a WFDS control service. Specifically, an object of the present invention is to provide a method for a controller device to remotely control a controlling device.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To solve the aforementioned technical problem, a method of performing a control service performed by a first wireless device to remotely control a second device, the method comprising: discovering the second wireless device by the first wireless device; receiving command information supported by the second wireless device from the second wireless device by the first wireless device when the second wireless device is discovered; transmitting command identification information for identifying a command, which is to be processed by the second wireless device, to the second wireless device by the first wireless device; and receiving a feedback on a process result of the command from the second wireless device.

To solve the aforementioned technical problem, a method of performing a control service capable of remotely controlling a second wireless device, which is performed by a first wireless device, the method comprising: discovering the second wireless device through a first interface; performing association with the discovered second wireless device, wherein if the first interface is off, discovery of the second wireless device through the first interface is performed after the first interface is turned on in a manner that the second wireless device receives a turn on message from the first wireless device through a second interface; receiving status information of the second wireless device and capability information of the second wireless device from the second wireless device; and if the second wireless device is in turn off status, transmitting a turn on data for turning on the second wireless device to the second wireless device.

To solve the aforementioned technical problem, a first wireless device performing a control service, comprising: a display unit; a transceiver; and a processor is configured to control the display unit and the transceiver, wherein the processor is further configured to: control the transceiver to receive command information supported by the second wireless device from a second wireless device when the second wireless device is discovered, control the transceiver to transmit command identification information for identifying a command, which is to be processed by the second wireless device, to the second wireless device, control the transceiver to receive a feedback on a process result of the command from the second wireless device.

To solve the aforementioned technical problem, a first wireless device performing a control service, comprising: a transceiver; and a processor is configured to control the transceiver, wherein the processor is further configured to: control the transceiver to transmit command information supported by the first wireless device to a second wireless device when the second wireless device is discovered, control the transceiver to process a command corresponding to the command identification information when command identification information is received from the second wireless device, control the transceiver to transmit a feedback on a process result of the command to the second wireless device.

The technical objects of the present invention will not be limited only to the technical objects described above. Accordingly, technical objects that have not been mentioned above or additional technical objects of the present application may become apparent to those having ordinary skill in the art from the description presented below.

### Advantageous Effects

According to the present invention, it is able to provide a method of providing a WFDS control service and an apparatus therefor. Specifically, according to the present invention, it is able to provide a method for a controller device to remotely control a controlling device.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 illustrates a diagram for an example of a structure of IEEE 802.11 system to which the present invention is applicable;

FIG. 2 illustrates a diagram showing an exemplary Wi-Fi Direct network;

FIG. 3 illustrates a diagram showing a method for configuring a Wi-Fi Direct network;

FIG. 4 illustrates a diagram showing a neighboring discovery procedure;

FIG. 5 illustrates a diagram showing a new aspect of a Wi-Fi Direct network;

FIG. 6 illustrates a diagram showing a method for configuring a link for Wi-Fi Direct communication;

FIG. 7 illustrates a diagram showing a method for associating with a communication group that performs Wi-Fi Direct;

FIG. 8 illustrates a diagram showing a method for configuring a link for Wi-Fi Direct communication;

FIG. 9 illustrates a diagram showing a method for configuring a link that is associated with a Wi-Fi Direct communication group;

FIG. 10 is a diagram for explaining a WFDS framework configuration element;

FIG. 11 is a diagram for explaining a WFDS framework including a control service;

FIGS. 12 and 13 are diagrams for a topology of a Wi-Fi Direct control service;

FIG. 14 is a diagram for a procedure of initializing a Wi-Fi Direct control service between a controller device and a controlling device;

FIG. 15 is a diagram for an example of performing device discovery via an UPnP protocol;

FIG. 16 is a diagram for an example of remotely controlling a controlling device controlled by a controller device;

FIG. 17 is a diagram for an example of outputting a user interface;

FIG. 18 is a diagram for a service discovery procedure between a controller device and a controlling device;

FIG. 19 is a diagram for a structure of information elements included in service information;

FIG. 20 is a diagram for a capability negotiation procedure between a controller device and a controlling device;

FIG. 21 is a flowchart for an example of transmitting UI information;

FIG. 22 is a diagram for an example of transmitting UI information appropriate for resolution of a controller device;

FIG. 23 is a flowchart for a different example of updating UI information;

FIG. 24 is a diagram of an example for a controller device to configure a UI based on received UI information;

FIG. 25 is a diagram for a different example of transmitting UI information;

FIG. 26 is a diagram for an example of a descriptor file (UI transmission descriptor) for transmitting UI information;

FIG. 27 is a diagram for an example of transmitting an identifier of a command corresponding to a selected object to a controlling device according to selection of a specific object;

FIG. 28 is a diagram for an example of transmitting an identifier of a selected object to a controlling device according to selection of a specific object;

FIG. 29 is a diagram for an example of transmitting information on a coordinate on which a touch input is received to a controlling device according to the touch input received on a user interface;

FIG. 30 is a diagram for explaining an example of remotely turning on a controlling device by a controller device;

FIGS. 31 and 32 are diagrams for an API (application program interface) between a controller device and a controlling device used for turning on the controlling device by the controller device;

FIG. 33 is a diagram for an example of checking whether or not a controlling device is turned on which is checked by a controller device via NAN discovery;

FIG. 34 is a diagram for an example of remotely turning on a controlling device by a controller device;

FIG. 35 is a diagram for architecture of a controller device for remotely turning on a controlling device;

FIG. 36 to FIG. 39 are diagrams for examples to which a control service is applied;

FIG. 40 is a block diagram for a configuration of a wireless device according one embodiment of the present invention.

### BEST MODE

### Mode for Invention

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details.

Occasionally, to prevent the present invention from getting unclear, structures and/or devices known to the public are skipped or can be represented as block diagrams centering on the core functions of the structures and/or devices. Wherever possible, the same reference numbers will be used throughout the drawings to refer to the same or like parts.

Specific terminologies used for the following description may be provided to help the understanding of the present invention. And, the use of the specific terminology may be modified into other forms within the scope of the technical idea of the present invention.

Embodiments of the present invention may be supported by the disclosed standard documents of at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document may be supported by the above standard documents.

The following description may apply to various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE adopts OFDMA in downlink (hereinafter abbreviated) DL and SC-FDMA in uplink (hereinafter abbreviated UL). And, LTE-A (LTE-Advanced) is an evolved version of 3GPP LTE.

For clarity, the following description mainly concerns IEEE 802.11 system, by which the technical features of the present invention may be non-limited.

Structure of WLAN System

FIG. 1 illustrates a diagram for an example of a structure of IEEE 802.11 system to which the present invention is applicable.

IEEE 802.11 structure may include a plurality of components and WLAN supportive of transparent STA mobility for an upper layer can be provided by interactions of the components. A basic service set (BSS) may correspond to a basic configuration block in IEEE 802.11 LAN. FIG. 1 shows one example that two basic service sets (BSS 1 and BSS 2) exist and that 2 STAs are included as members of each BSS. In particular, STA 1 and STA 2 are included in the BSS 1 and STA 3 and STA 4 are included in the BSS 2. In FIG. 1, an oval indicating the BSS can be understood as indicating a coverage area in which the STAs included in the corresponding BSS maintain communications. This area may be named a basic service area (BSA). Once the STA moves away from the BSA, it is unable to directly communicate with other STAs within the corresponding BSA.

A BSS of a most basic type in IEEE 802.11 LAN is an independent BSS (IBSS). For instance, IBSS can have a minimum configuration including 2 STAs only. Moreover, the BSS (e.g., BSS 1 or BSS 2) shown in FIG. 1, which has the simplest configuration and in which other components are omitted, may correspond to a representative example of the IBSS. Such a configuration is possible if STAs can directly communicate with each other. The above-configured LAN is not configured by being designed in advance but can be configured under the necessity of LAN. And, this may be called an ad-hoc network.

If an STA is turned on/off or enters/escapes from a BSS area, membership of the STA in a BSS can be dynamically changed. In order to obtain the membership in the BSS, The STA can join the BSS using a synchronization procedure. In order to access all services of the BSS based structure, the STA should be associated with the BSS. This association may be dynamically configured or may include a use of a DSS (distribution system service).

Layer Structure

The operation of the STA which is operated in the wireless LAN system may be described in view of layer structure. In aspect of device configuration, layer structure may be implemented by a processor. The STA may have a structure of a plurality of layers. For example, a layer structure handled by the 802.11 standard document mainly includes a MAC sublayer and a physical (PHY) layer on a data link layer (DLL). The PHY layer may include a physical layer convergence procedure (PLCP) entity, a physical medium dependent (PMD) entity, etc. The MAC sublayer and the PHY layer conceptionally include management entities called MAC sublayer management entity (MLME) and physical layer management entity (PLME), respectively. These entities provide a layer management service interface that operates a layer management function.

In order to provide exact MAC operation, an SME (Station Management Entity) is present within each STA. The SME is a layer independent entity that may be viewed as residing in a separate management plane or as residing “off to the side.” The exact functions of the SME are not specified in this document, but in general this entity may be viewed as being responsible for such functions as the gathering of layer-dependent status from the various layer management entities (LMEs), and similarly setting the value of layer-specific parameters. The SME may perform such functions on behalf of general system management entities and may implement standard management protocols.

The aforementioned entities interact in various ways. For example, the entities may interact by exchanging GET/SET primitives. The primitive means a set of elements or parameters related to a specific object. XX-GET.request primitive is used for requesting the value of the given MIB attribute (management information base attribute). XX-GET.confirm primitive is used for returning the appropriate MIB attribute value if status is “success,” otherwise returning an error indication in the Status field. XX-SET.request primitive is used for requesting that the indicated MIB attribute be set to the given value. If this MIB attribute implies a specific action, this requests that the action be performed. And, XX-SET. confirm primitive is used such that, if status is “success,” this confirms that the indicated MIB attribute has been set to the requested value, otherwise it returns an error condition in the status field. If this MIB attribute implies a specific action, this confirms that the action has been performed.

Also, the MLME and the SME may exchange various MLME_GET/SET primitives through MLME SAP (Service Access Point). Also, various PLME_GET/SET primitives may be exchanged between PLME and SME through PLME_SAP, and may be exchanged between the MLME and PLME through MLME-PLME_SAP.

Evolution of Wireless LAN

Standards for Wireless Local Area Network (WLAN) technology have been developed by Institute of Electrical and Electronics Engineers (IEEE) 802.11 group. IEEE 802.11a and 802.11b use an unlicensed band at 2.4 GHz or 5 GHz. IEEE 802.11b provides a transmission rate of 11 Mbps and IEEE 802.11a provides a transmission rate of 54 Mbps. IEEE 802.11g applies Orthogonal Frequency-Division Multiplexing (OFDM) at 2.4 GHz to provide a transmission rate of 54 Mbps. IEEE 802.11n may use Multiple Input Multiple Output (MIMO)-OFDM, and provide a transmission rate of 300 Mbps. IEEE 802.11n may support a channel bandwidth up to 40 MHz to provide a transmission rate of 600 Mbps.

A direct link setup (DLS) related protocol under the environment according to IEEE 802.11e is based on QBSS (Quality BSS (basic service set)) that BSS supports QoS (Quality of Service). In QBSS, AP as well as non-AP STA is a QAP (Quality AP) that supports QoS. However, under the WLAN environment (for example, WLAN environment according to IEEE 802.11a/b/g) which is currently commercialized, although the non-AP STA is a QSTA (Quality STA) that supports QoS, the AP is likely to be a legacy AP that fails to support QoS. As a result, there is a limitation that DLS service cannot be used even in case of the QSTA under the WLAN environment which is currently commercialized.

Tunneled direct link setup (TDLS) is a wireless communication protocol which is newly suggested to solve such a limitation. TDLS, although not supporting QoS, enables QSTAs to set a direct link even under the WLAN environment such as IEEE 802.11a/b/g which is currently commercialized and set a direct link even in case of a power save mode (PSM). Accordingly, TDLS prescribes all the procedures for enabling QSTAs to set a direct link even at BSS managed by the legacy AP. Hereinafter, a wireless network that supports TDLS will be referred to as a TDLS wireless network.

Wi-Fi Direct Network

The WLAN according to the related art has mainly handled the operation of an infrastructure BSS that a radio access point (AP) functions as a hub. The AP performs a physical layer support function for wireless/wire connection, a routing function for devices on the network, and service provision for adding/removing a device to/from the network. In this case, devices within the network are not directly connected with each other but connected with each other through the AP.

As technology for supporting direct connection between devices, enactment of Wi-Fi Direct standard has been discussed.

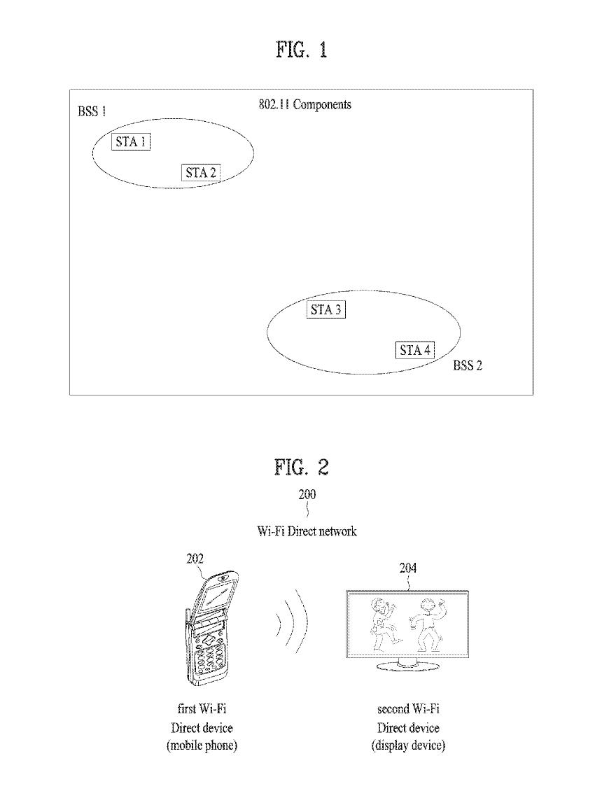

FIG. 2 illustrates a diagram showing an exemplary Wi-Fi Direct network. The Wi-Fi Direct network is a network that enables Wi-Fi devices to perform device-to-device (D2D) (or peer-to-peer (P2P)) communication even without association with a home network, office network and hot spot network, and has been suggested by Wi-Fi Alliance. Hereinafter, Wi-Fi Direct based communication will be referred to as Wi-Fi Direct D2D communication (simply D2D communication) or Wi-Fi Direct P2P communication (simply, P2P communication). Also, a device that performs Wi-Fi Direct P2P will be referred to as Wi-Fi Direct P2P device, simply referred to as P2P device or Peer device.

Referring to FIG. 2, the Wi-Fi Direct network (200) may include at least one Wi-Fi device that includes a first P2P device (202) and a second P2P device (204). The P2P device may include Wi-Fi supporting devices, for example, a display device, a printer, a digital camera, a projector, a smart phone, etc. In addition, the P2P device may include a non-AP STA and an AP STA. In this example, the first P2P device (202) is a smart phone, and the second P2P device (204) is a display device. The P2P devices of the Wi-Fi Direct network may directly be interconnected. In more detail, P2P communication may mean that a signal transmission path between two P2P devices is directly configured in the corresponding P2P devices without passing through a third device (e.g., AP) or a legacy network (e.g., a network accessed to WLAN through an AP). In this case, a signal transmission path directly configured between two P2P devices may be limited to a data transmission path. For example, P2P communication may mean that a plurality of non-STAs transmit data (e.g., voice, image, text information, etc.) without passing through the AP. A signal transmission path for control information (e.g., resource allocation information for P2P configuration, wireless device identification information, etc.) may directly be configured between P2P devices (e.g., non-AP STA to non-AP STA, non-AP STA to AP), may be configured between two P2P devices (e.g., non-AP to non-AP STA) through the AP, or may be configured between the AP and the corresponding P2P device (e.g., AP to non-AP STA #1, AP to non-AP STA #2).

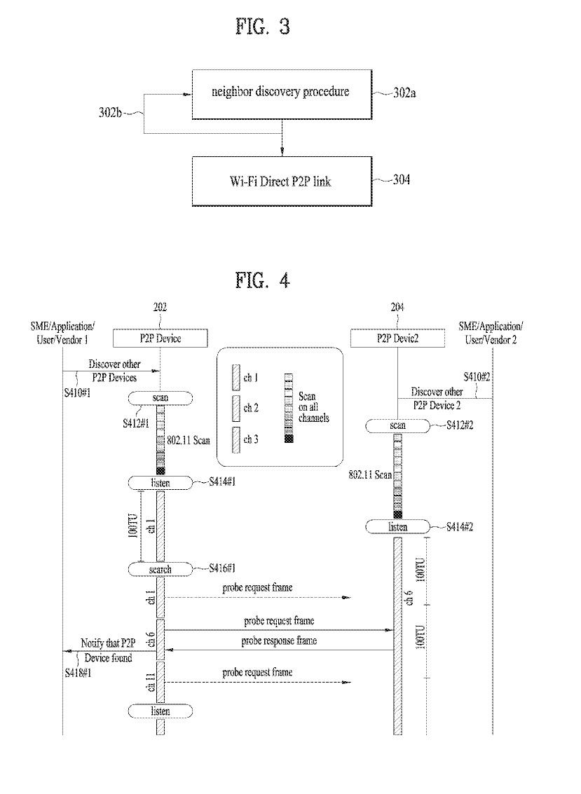

FIG. 3 illustrates a diagram showing a method for configuring a Wi-Fi Direct network.

Referring to FIG. 3, the Wi-Fi Direct network setup procedure may be largely classified into two procedures. The first procedure is a neighbor discovery (ND) procedure (S302a), and the second procedure is a P2P link configuration and communication procedure (S304). Through the neighbor discovery procedure, the P2P device (e.g., 202 of FIG. 2) searches for another neighbor P2P device (e.g., 204 of FIG. 2) within (its own radio) coverage, and may obtain information required for association (e.g., pre-association) with the corresponding P2P device. In this case, the pre-association may mean a second layer pre-association in a radio protocol. For example, information required for the pre-association may include identification information of the neighbor P2P device. The neighbor discovery procedure may be carried out per available radio channel (S302b). Afterwards, the P2P device (202) may perform Wi-Fi Direct P2P link configuration/communication with another P2P device (204). For example, after the P2P device (202) is associated with a peripheral P2P device (204), the P2P device (202) may determine whether the corresponding P2P device (204) is a P2P device incapable of satisfying service requirements of a user. To this end, after the P2P device (202) is second layer pre-associated with the peripheral P2P device (204), the P2P device (202) may search for the corresponding P2P device (204). If the corresponding P2P device (204) does not satisfy service requirements of the user, the P2P device (202) may sever the second layer association configured for the corresponding P2P device (204), and may configure the second layer association with another P2P device. By contrast, if the corresponding P2P device (204) satisfies the service requirements of the user, the two P2P devices (202 and 204) may transmit and receive signals through a P2P link.

FIG. 4 illustrates a diagram showing a neighboring discovery procedure. The example of FIG. 4 may be understood as an operation between the P2P device (202) and the P2P device (204) shown in FIG. 3.

Referring to FIG. 4, the neighbor discovery procedure of FIG. 3 may be initiated by indication of station management entity (SME)/application/user/vendor (S410), and may be classified into a scanning step (S412) and finding steps (S414 to S416). The scanning step (S412) may include the operation for scanning all available RF channels according to 802.11 schemes. Through the above-mentioned operation, the P2P device may confirm the best operation channel. The finding steps (S414 to S416) may include a listening mode (S414) and a search mode (S416). The P2P device may alternately repeat the listening mode (S414) and the search mode (S416). The P2P devices (202 and 204) may perform active search by using a probe request frame in the search mode (S416). For rapid search, the search range may be limited to social channels denoted by Channels #1, #6, #11 (2412, 2437, 2462 MHz). In addition, the P2P devices (202 and 204) may select only one channel from three social channels in the listening mode (S414), and maintain a reception status. In this case, if the other P2P device (e.g., 202) receives the probe request frame transmitted in the search mode, the P2P device (e.g., 204) generates a probe response frame in response to the received probe request frame. A time of the listening mode (S414) may be given at random (e.g., 100, 200, 300 time unit (TU)). The P2P devices continuously repeat the search mode and the reception mode so that they may reach a common channel. After the P2P device discovers another P2P device, the P2P device may discover/exchange a device type, a manufacturer, or a familiar device name by using the probe request frame and the probe response frame such that the P2P device may selectively be coupled to the corresponding P2P device. If the P2P device discovers the peripheral P2P device and obtains necessary information through the neighbor discovery procedure, the P2P device (e.g., 202) may notify SME/application/user/vendor of the P2P device discovery (S418).

Presently, P2P may be mainly used for semi-static communication such as remote printing, photo sharing, etc. However, due to generalization of Wi-Fi devices and location based services, P2P availability is gradually increased. For example, it is expected that the P2P device will actively be used for social chatting (for example, wireless devices subscribed to Social Network Service (SNS) recognize radio devices located in a neighboring region on the basis of the location based service and transmit and receive information), location-based advertisement provision, location-based news broadcasting, and game interaction between wireless devices. For convenience of description, such P2P application will hereinafter be referred to as new P2P application.

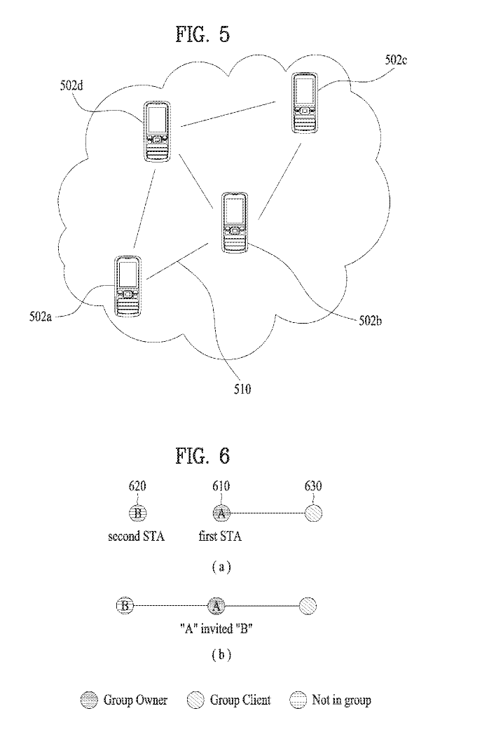

FIG. 5 illustrates a diagram showing a new aspect of a Wi-Fi Direct network.

The example of FIG. 5 may be understood as Wi-Fi Direct network aspect for use in the case in which new P2P application (e.g., social chatting, location-based service provision, game interaction, etc.) is applied.

Referring to FIG. 5, a plurality of P2P devices (502a-502d) performs P2P communication (510) in the Wi-Fi Direct network, P2P device(s) constituting the Wi-Fi Direct network may be changed at any time due to movement of the P2P device(s), and a new Wi-Fi Direct network may be dynamically generated or deleted within a short time. As described above, characteristics of the new P2P application indicate that P2P communication may dynamically be performed and terminated within a short time among a plurality of P2P devices in the dense network environment.

FIG. 6 illustrates a diagram showing a method for configuring a link for Wi-Fi Direct communication.

As shown in FIG. 6a, a first STA (610) (hereinafter, referred to as “A”) is being operated as a group owner during conventional Wi-Fi Direct communication. If the A (610) discovers a second STA (620) (hereinafter, referred to as “B”), which is a new Wi-Fi Direct communication target and does not perform Wi-Fi Direct communication, during communication with a group client (630) of conventional Wi-Fi Direct communication, the A (610) tries link setup with the B (620). In this case, new Wi-Fi Direct communication is Wi-Fi Direct communication between the A (610) and the B (620), and since the A is a group owner, the A may perform communication setup separately from communication of the conventional group client (630). Since one Wi-Fi Direct group may include one group owner and one or more group clients, as shown in FIG. 6b, a Wi-Fi Direct link may be set as the A (610) which is one group owner is satisfied. In this case, the A (610) invites the B (620) to the conventional Wi-Fi Direct communication group, and in view of Wi-Fi Direct communication characteristic, WFD communication between the A (610) and the B (620) and between the A (610) and the conventional group client (630) may be performed. Wi-Fi Direct communication is supported selectively based on the device's capability.

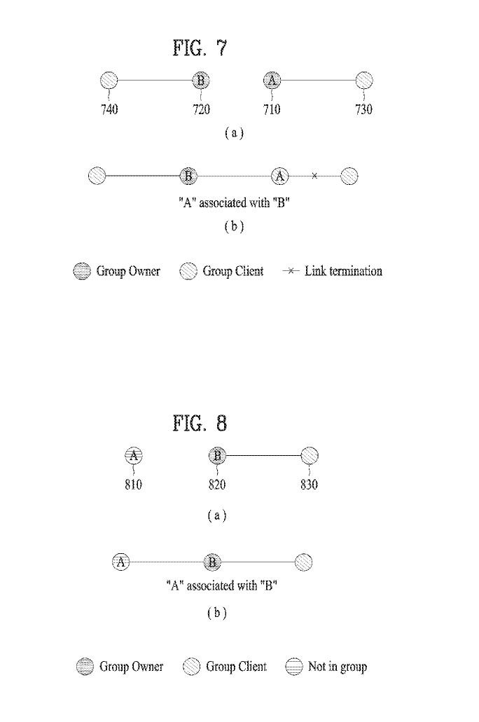

FIG. 7 illustrates a diagram showing a method for associating with a communication group that performs Wi-Fi Direct.

As shown in FIG. 7a, a first STA (710) (hereinafter, referred to as “A”) is performing communication as a group owner for a group client (730), and a second STA (720) (hereinafter, referred to as “B”) is performing communication as a group owner for a group client (740). As shown in FIG. 7b, the A (710) may terminate conventional Wi-Fi Direct communication and may perform association with a Wi-Fi Direct communication group to which the B (720) belongs. Since the A (710) is a group owner, the A (710) becomes a group client. Preferably, the A (710) terminates the conventional Wi-Fi Direct communication before requesting association with the B (720).

FIG. 8 illustrates a diagram showing a method for configuring a link for Wi-Fi Direct communication.

As shown in FIG. 8a, a second STA (820) (hereinafter, referred to as “B”) is being operated as a group owner during conventional Wi-Fi Direct communication. If the B (820) is performing conventional Wi-Fi Direct communication with a group client (830), a first STA (810) (hereinafter, referred to as “A”), which does not perform the Wi-Fi Direct communication, discovers the B (820) and tries link setup for new Wi-Fi Direct communication with the B (820). In this case, if the B (820) accepts link setup, a new Wi-Fi Direct communication link between the A (810) and the B (820) is set, and the A (810) is operated as a client of conventional Wi-Fi Direct group of the B (820). This case corresponds to the case where the A (810) performs association with the Wi-Fi Direct communication group of the B (820). The A (810) may only perform Wi-Fi Direct communication with the B (820) which is a group owner, and Wi-Fi Direct communication between the A (810). Wi-Fi Direct communication is supported selectively based on the device's capability.

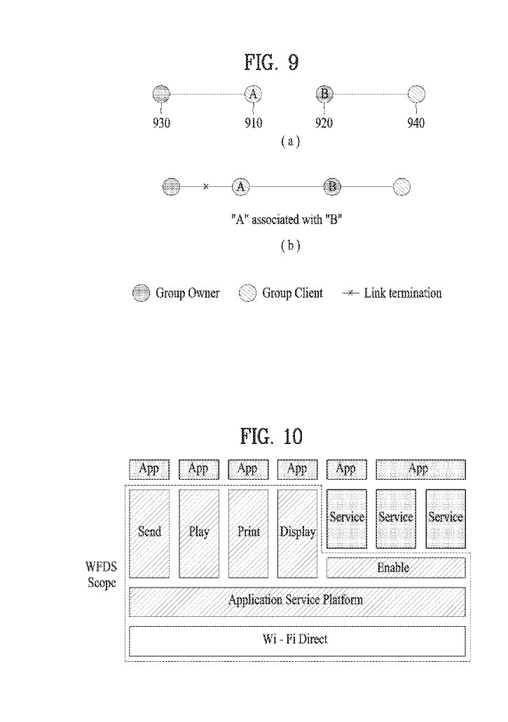

FIG. 9 illustrates a diagram showing a method for configuring a link that is associated with a Wi-Fi Direct communication group.

As shown in FIG. 9a, a first STA (910) (hereinafter, referred to as “A”) is performing Wi-Fi Direct communication as a group client for a group owner (930). At this time, the A (910) discovers a second STA (920) (hereinafter, referred to as “B”), which is performing communication as a group owner for a group client (940) of another Wi-Fi Direct communication, and terminates a link with the group owner (930). And, the A (910) may perform association with Wi-Fi Direct of the B (920).

Wi-Fi Direct Service (WFDS)

Wi-Fi Direct is the network connection standard technology defined to include an operation of a link layer. Since the standard of an application operated in an upper layer of a link configured by Wi-Fi Direct is not defined, it is difficult to support compatibility in the case that the application is driven after devices which support Wi-Fi Direct are interconnected. To solve this problem, standardization of the operation of the upper layer application called Wi-Fi Direct Service (WFDS) has been discussed by the Wi-Fi Alliance (WFA).

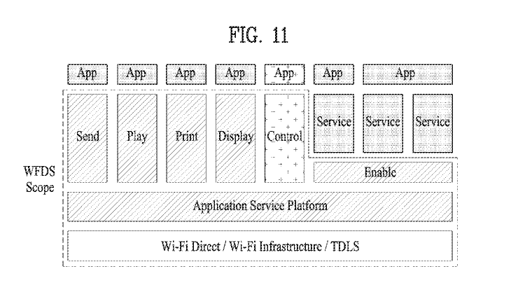

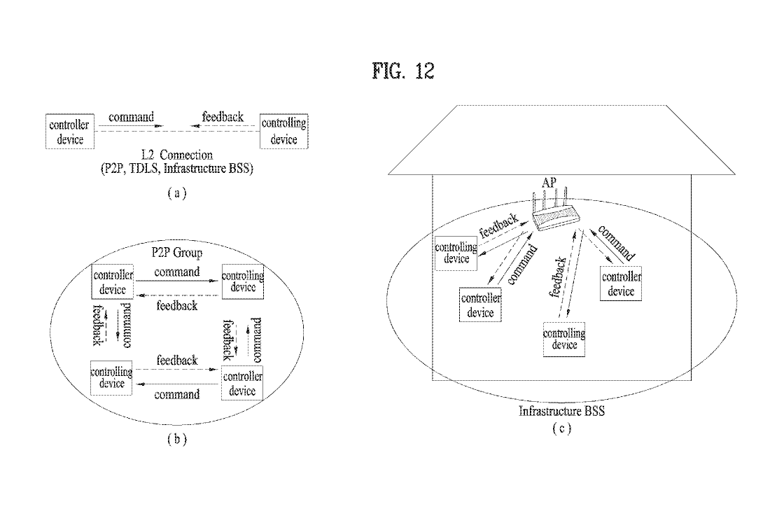

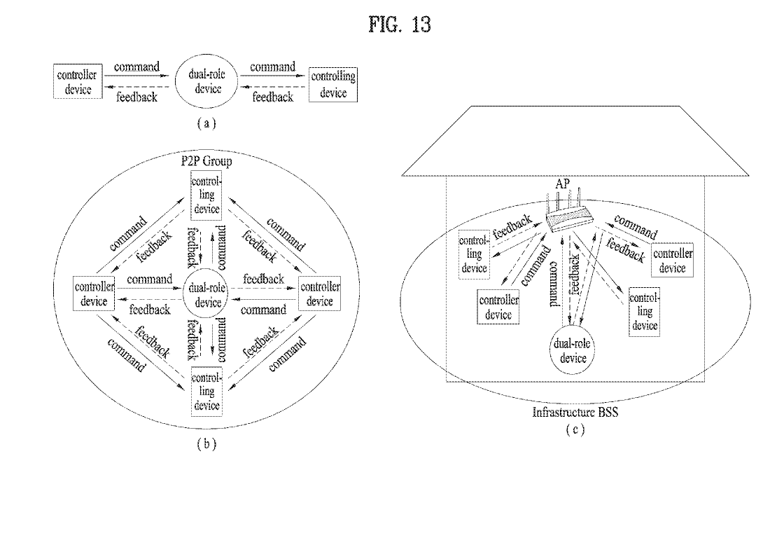

FIG. 10 illustrates a diagram illustrating WFDS framework components.

A Wi-Fi Direct layer of FIG. 10 means a MAC layer defined by the Wi-Fi Direct standard. The Wi-Fi Direct layer may include software compatible with the Wi-Fi Direct standard. Wireless connection may be configured below the Wi-Fi Direct layer by a physical layer (not shown) compatible with WiFi PHY layer. A platform called an ASP (Application Service Platform) is defined above the Wi-Fi Direct layer.

The ASP is a logical entity that implements functions required for services. The ASP is a common shared platform, and may process tasks such as device discovery, service discovery, ASP session management, connection topology management and security between an application layer above the ASP and the Wi-Fi Direct layer below the ASP.

A service layer is defined above the ASP. The service layer includes use case specific services. The WFA defines four basis services, Send, Play, Display and Print services. The four basic services defined in the WFA will be described briefly. First of all, Send means service and application that may perform file transfer between two WFDS devices. The Send service may be referred to as a file transfer service (FTS) in that it is intended for file transfer between peer devices. Play means a service and application that shares or streams audio/video (A/V), photo, music, etc. based on DLNA (Digital Living Network Alliance) between two WFDS devices. Print means a service and application that enables documents and photos to be output between a device having contents such as documents, photos, and so on, and a printer. Display means a service and application that enables screen sharing between a Miracast source and a sink of WFA.

An enable API (Application Program Interface) shown in FIG. 10 is defined to use an ASP common platform in the case that a third party application in addition to basic service defined by the WFA is supported. The service defined for the third party application may be used by one application only, or may be used generally (or commonly) by various applications.

Hereinafter, for convenience of description, the service defined by the WFA will be referred to as a WFA service, and the service newly defined by the third party not the WFA will be referred to as an enable service.

The application layer may provide a user interface (UI), and serves to express information to be recognized by the user and transfer an input of the user to a lower layer.

The present invention intends to propose a control service capable of remotely controlling another device except the listed WFDS. The control service defined by the present invention is explained in the following in more detail.

Wi-Fi Direct Control

As shown in an example of FIG. 11, similar to a predefined WFDS, a Wi-Fi Direct control service can be defined as a service predefined at the top of ASP. If the Wi-Fi Direct control service and the predefined WFDS are located at an identical level, the ASP can support an identical primitive not only to the predefined WFDS (i.e., Send, Play, Print and Display service) but also to the Wi-Fi Direct control service. Although it is not depicted, the Wi-Fi Direct control service can also be defined as an enable service at the top of the ASP.

A device capable of performing the Wi-Fi Direct control service may correspond to a controller device or a controlling device. The controller device corresponds to a device equipped with capability capable of remotely controlling the controlling device in wireless. The controller device may correspond to an electronic device capable of performing Wi-Fi communication including a smartphone, a tablet PC, a laptop and the like. In this case, it may be preferable to install such a mean capable of receiving a user input as a touch screen, a keypad, a hardware button (or software), a keyboard and the like in the controller device.

The controlling device corresponds to a device remotely controlled by the controller device in wireless and may correspond to an electronic device capable of performing Wi-Fi communication including a digital TV, a washing machine, a light, a refrigerator and the like.

A device capable of performing both a role of the controller device and a role of the controlling device may be referred to as a dual-role device.

FIGS. 12 and 13 are diagrams for a topology of a Wi-Fi Direct control service.

In order to perform a Wi-Fi Direct control service, it is necessary to have at least one or more controller devices and one or more controlling devices. As shown in an example of FIG. 12 (a), if an L2 connection is established between a controller device and a controlling device, the controller device can transmit a command to the controlling device through the L2 connection. The controlling device processes the command received from the controller device and may be then able to transmit a feedback on the command to the controller device through the L2 connection. In this case, the feedback may indicate whether or not the command received by the controlling device is normally processed. As an example, if the command received by the controlling device is normally processed, the controlling device can transmit a feedback indicating that the received command is normally processed to the controller device. On the contrary, if the command received by the controlling device is abnormally processed, the controlling device can transmit a feedback indicating that the received command is not normally processed to the controller device.

In this case, the L2 connection can be established based on a P2P between devices, TDLS, an infrastructure BSS or the like. The P2P and the TDLS indicate that a direct communication channel is formed between a controller device and a controlling device. On the contrary, the infrastructure BSS may indicate that a controller device and a controlling device are communicating with each other through an access point (AP).

If a P2P link or a TDLS link is established between a controller device and a controlling device, the controller device can transmit a command to the controlling device through the P2P link or the TDLS link. In this case, the controller device can establish the P2P link or the TDLS link with each of a plurality of controlling devices. In this case, the controller device can transmit a command to a controlling device through each P2P link or TDLS link to remotely control the controlling device in wireless (refer to FIG. 12 (b)).

Having received the command from the controller device, the controlling device can transmit a feedback to the controller device through a P2P link or a TDLS link. The controlling device can also establish the P2P link or the TDLS link with a plurality of controller devices. In this case, the controlling device may be able to transmit a command to a controller device, which has transmitted the command, among a plurality of the controller devices.

If a controller device and a controlling device are connected with each other through an AP, the controller device transmits a command to the controlling device through the AP and the controlling device can transmit a feedback to the controller device through the AP (refer to FIG. 12 (c)). An infrastructure BSS may include a plurality of controller devices and a plurality of controlling devices. In this case, a controller device may transmit a command to a plurality of the controlling device through an AP. A controlling device can be remotely controlled by a plurality of controller devices in wireless.

A dual-role device plays a role of a controller device transmitting a command to a controlling device and plays a role of a controlling device receiving a command from a controller device at the same time (refer to FIG. 13 (a)). If the dual-role device transmits a command to a controlling device, the dual-role device can receive a feedback from the controlling device. If the dual-role device receives a command from a controller device, the dual-role device can transmit a feedback to the controller device.

The dual-role device can establish a P2P link or a TDLS link with a plurality of controlling devices or establish a P2P link or a TDLS link with a plurality of controller devices. In this case, the dual-role device can transmit a command to a plurality of the controlling devices and may be able to receive commands from a plurality of the controller devices (refer to FIG. 13 (b)).

A plurality of controller devices and a plurality of controlling devices including a dual-role device can be included in an infrastructure BSS. In this case, the dual-role device can transmit a command for remotely controlling a plurality of the controlling devices in wireless through an AP and may be able to receive commands from a plurality of the controller devices through the AP (refer to FIG. 13 (c)).

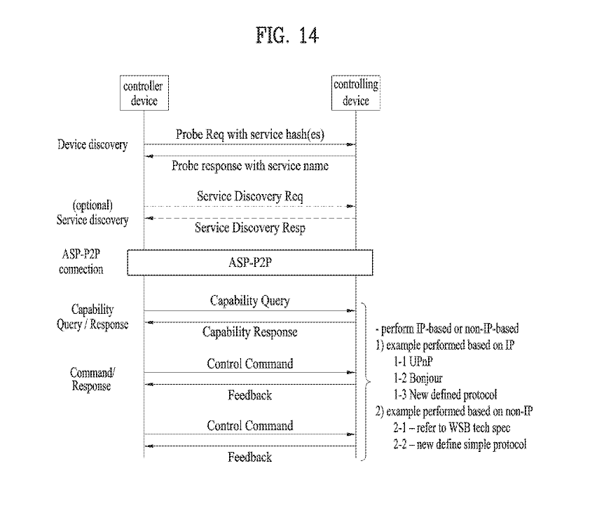

FIG. 14 is a diagram for a procedure of initializing a Wi-Fi Direct control service between a controller device and a controlling device.

First of all, a controller device and a controlling device can discover the existence of a counterpart device via an initial device discovery procedure. Specifically, if the controller device transmits a probe request frame to the controlling device, the controlling device can transmit a probe response frame to the controller device in response to the probe request frame. The controller device and the controlling device can discover a counterpart device through the probe request frame and the probe response frame. The controller device can broadcast the probe request frame or unicast the probe request frame to a specific device only.

In this case, the probe request frame can include a hash value of which a name of a service intended to be discovered by the controller device or a name of a service capable of being supported by the controller device is converted in a manner of being hashed.

Having received the probe request frame, the controlling device can check whether or not the controlling device supports a service for which the controller device searches via hash matching. If it is determined as the controlling device supports the service for which the controller device searches, the controlling device can transmit a probe response frame including a name of the service to the controller device.

A name of a Wi-Fi Direct control service can include a text string for identifying a control service and a text string for identifying a controlling device. As an example, a service name of a controller device can include ‘org.wi-fi.wfds.control.controller’ and a controlling device can include ‘org.wi-fi.wfds.control.controlling’ or ‘org.wi-fi.wfds.control.controlled’. In this case, ‘org.wi-fi. wfds’ indicates a WFDS predefined by WFA and ‘control’ may indicate a control service. ‘controller’ indicates a controller device for remotely controlling a controlling device and ‘controlling’ or ‘controlled’ may indicate a controlling device capable of being remotely controlled by a controller device.

In this case, a service name of a controlling device can further include a text string for indicating a type of the controlling device. The text string for indicating the type of the controlling device may have 2-step depth of which a text string for indicating a main category and a text string for indicating a sub category, which is positioned at the bottom of the main category, are combined with each other. Or, the text string for indicating the type of the controlling device may have 1-step depth to directly indicate a category to which the controlling device belongs thereto.

As an example, Table 1 in the following shows an example of categorizing controlling devices according to a type.

TABLE 1

| Category | ID | Sub category | ID |
|---|---|---|---|
| Computer | 1 | | |
| Input Device | 2 | | |
| Printer, Scanner, Faxes | 3 | | |
| Camera | 4 | | |
| Storage | 5 | | |
| Network Device | 6 | | |
| Display | 7 | | |
| Multimedia | 8 | | |
| Game console | 9 | | |
| Telephone | 10 | | |
| Audio Device | 11 | | |
| Home Appliance | 12 | Air Conditioner | 1 |
| | | Wash Machine | 2 |
| | | Cooking Machine | 3 |
| | | Refrigerator | 4 |
| | | Cleaning Machine | 5 |
| Home Automation | 13 | | |
| System | | | |
| Others | 255 | | |

Referring to Table 1, a service name of an air conditioner can be defined as follows.

org.wi-fi.wfds.control.controlling.homeappliance.aircon or org.wi-fi.wfds. control.controlling.aircon.

The category and the sub category shown in Table 1 are just an example only for clarity of explanation. The present invention may be non-limited by the example. A category name or a sub category name different from the name shown in Table 1 can also be used to define a service name of a controlling device.

As an example, a service name of a digital TV can be defined as follows.

org.wi-fi.wfds.control.controlling.display.dtv or org.wi-fi.wfds. control.controlling.dtv

A service name of a lighting device can be defined as follows.

org.wi-fi.wfds.control.controlling.homeauto.light or org.wi-fi.wfds. control.controlling.light

As mentioned earlier in the foregoing example, a service name of a controlling device may have 4-step depth such as control.controlling.(main category name).(sub category name) except a fixed part such as org.wi-fi.wfds or may have 3-step depth such as control.controlling.(category name) except the fixed part.

As a different example, a controlling device can include device type information of the controlling device in a probe response frame as an information element (IE). As an example, the device type information can be included in a device type attribute field in a WSC (Wi-Fi Simple Configuration) information element. The device type information can be included in the WSC information element as a hexadecimal number or a text string readable by a user according to a category to which the controlling device belongs thereto.

Having received the probe response frame from the controlling device in response to the probe request frame, the controller device can check a type of the controlling device through a service name included in the probe response frame or an information element included in the probe response frame.

If the probe response frame is received, a service discovery procedure can be performed between the controller device and the controlling device. Yet, since the service discovery procedure is not a mandatory procedure, the service discovery procedure can be optionally performed only when both the controller device and the controlling device support the service discovery procedure.

Specifically, the controller device can transmit a service request frame including a name of a service for which the controller device intends to search to the controlling device. The service request frame can include a complete name of the service or a prefix of the name of the service for which the controller intends to search.

The controlling device performs a service name matching procedure. If the controlling device is able to support the service for which the controller device is searching, the controlling device can transmit a service request frame including a service name to the controller device. In this case, when the service name matching procedure is performed, it may be able to utilize a prefix search. Specifically, the controlling device can include a complete service name, which includes a service name included in the service request frame as a prefix, in the service request frame.

If the device discovery procedure or the service discovery procedure is completed, an ASP session and a P2P link can be established between the controller device and the controlling device.

Subsequently, a capability negotiation procedure can be performed between the controller device and the controlling device. Specifically, the controller device transmits a capability query frame for querying capability of the controlling device to the controlling device and the controlling device transmits a capability response frame to the controller device in response to the capability query frame. In this case, the capability response frame can include a list of functions capable of remotely controlling the controlling device by the controller device.

As an example, Table 2 in the following shows a list of functions capable of being remotely controlled in the controlling device.

TABLE 2

| Function capable of being | |
|---|---|
| remotely controlled | Description |
| Turn on/off | Turn on or turn off a device |
| | (function for turning on/off a device) |
| Volume +/− | Volume up/down |
| | (e.g., function for controlling volume |
| | of TV or audio) |
| Mute | mute |
| | (e.g., function for setting TV or audio |
| | to mute state) |
| Output | output |
| | (e.g., function for initiating mirroring |
| | of external device to which projector is |
| | connected) |
| Navigation | Navigation key input such as up/down/ |
| Direction: | left/right |
| up/down/ | (e.g., function for inputting navigation |
| left/right | key in TV or laptop) |
| Enter | Enter key input |
| | (e.g., function for inputting enter key in |
| | TV or laptop) |
| Channel +/− | Channel up/down |
| | (e.g., function for changing channel in |
| | radio or TV) |
| Number 0-9 | Number key 0-9 input |
| | (e.g., function for inputting number in TV |
| | or laptop) |
| Character A-Z, | Upper case A-Z, lower case a-z or other |
| a-z, other | character key input |
| | (e.g., function for inputting character |
| | in TV or laptop) |
| Menu | Menu key input |
| | (e.g., function for calling menu in TV) |
| Temperature +/− | Temperature up/down |
| | (e.g., function for controlling preferred |
| | temperature in air conditioner) |
| Play/Pause/ | Play/Pause/Backward/Forward |
| Backward/Forward | (e.g., function for controlling playback of |
| | music or video in audio or video) |
| Next/Previous | Next/Previous |
| | (e.g., function for playing next song or |
| | previous song in audio) |
| Title | Title |
| | (e.g., function for checking title of |
| | broadcasting or title of music outputted |
| | in TV or audio) |
| Auto resize | Auto resize |
| | (e.g., function for changing screen resolution |
| | in accordance with display size in monitor or |
| | projector) |
| Blind screen | Blinding screen |
| | (e.g., function for terminating mirroring |
| | in projector) |
| Start/pause | Start/pause |
| | (e.g., function for starting or pausing |
| | recording in recorder) |
| Dim out/light up | Dim out/light up |
| | (e.g., function for increasing or decreasing |
| | brightness of lighting device) |
| Request Status | Status information request |
| | (e.g., remaining time for washing machine |
| | to complete washing) |
| Diagnostic Mode | Enter diagnostic mode |
| | (e.g., function for entering diagnostic mode |
| | to diagnose error of device) |
| Vendor Specific | Function specifically determined by |
| Action | manufacturer |

Having received the capability response frame, the controller device can check functions capable of being remotely controlled in the controlling device.

Unlike the example shown in FIG. 14, the controlling device can transmit a list of functions capable of being remotely controlled to the controller device via a discovery response frame before the ASP session and the P2P link are established.

If the ASP session is established, the controlling device can transmit the list of functions capable of being remotely controlled to the controller device through an UPnP (Universal Plug and Play) device description or an UPnP service description. In this case, the device description or the service description may have an XML form.

If an IP connection already exists between the controller device and the controlling device before the device discovery procedure is performed (e.g., if a P2P link or a TDLS link is established between the controller device and the controlling device or an infrastructure BSS is formed by the controller device and the controlling device), the controller device and the controlling device may perform device discovery through an UPnP (Universal Plug and Play) protocol.

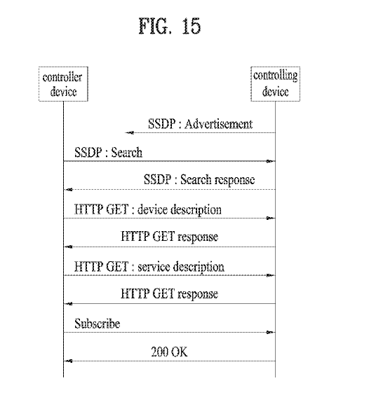

As an example, FIG. 15 is a diagram for an example of performing device discovery via an UPnP protocol.

A controlling device can periodically broadcast an SSDP (simple service discovery protocol) advertisement to a subnet. A controller device can complete discovery of the controlling device in a manner of receiving the SSDP advertisement broadcasted by the controlling device.

As a different example, the controller device transmits an SSDP search request and may be able to discover a controlling device in response to the SSDP search request. Specifically, the controller device can complete discovery of a controlling device in a manner of receiving an SSDP search response from the controlling device, which has received the SSDP search request.

If the controlling device is discovered, the controller device may make a request for a device description and a service description of the controlling device. The controlling device can provide the controller device with the device description and the service description in response to the request of the controller device. In this case, as mentioned in the foregoing description, the device description and the service description can include a list of functions capable of being remotely controlled by the controller device.

If the list of functions capable of being remotely controlled is checked, the controller device can transmit a command for remotely controlling the controlling device. The controlling device applies the received command and may be able to transmit a feedback on the received command to the controller device.

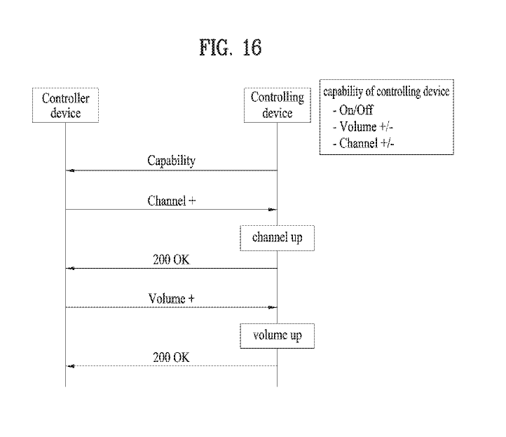

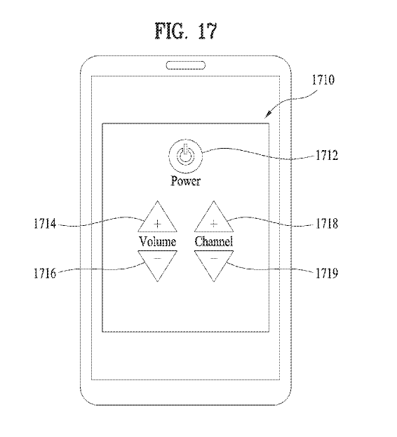

As an example, FIG. 16 is a diagram for an example of remotely controlling a controlling device controlled by a controller device. Assume that a function capable of remotely controlling a controlling device is checked as Turn On/Off, Volume+/−, Channel+/− through a capability negotiation procedure.

If a user pushes a button for increasing a channel of the controlling device through the controller device, the controller device can transmit a command for indicating to increase a channel to the controlling device.

Having received the channel up command from the controller device, the controlling device increases a channel of the controlling device and may be then able to transmit a feedback to the controller device to indicate that the channel up is successfully completed.

Subsequently, if a user pushes a button for increasing volume of the controlling device through the controller device, the controller device can transmit a command for indicating to increase volume to the controlling device.

Having received the volume up command from the controller device, the controlling device increase volume and may be then able to transmit a feedback to the controller device to indicate that the volume up is successfully completed.

A command data and a feedback data can be transmitted by a service session between the controller device and the controlling device. In this case, the service session can be managed by ASP. Service data including a command, a feedback and the like can be transmitted by an IP scheme or a non-IP scheme. Specifically, the service data can be transmitted using the IP scheme such as an UPnP protocol, a Bonjour protocol, a newly defined protocol and the like. Or, the service data can be transmitted using the non-IP scheme such as WSB (Wi-Fi serial bus) or a newly defined simple protocol.

Wi-Fi Direct Control—User Interface

If a list of functions is checked, it is necessary for the controller device to display a user interface (UI) at which buttons for remotely controlling the controlling device are deployed. As an example, if functions capable of remotely controlling the controlling device are checked as Turn On/Off, Volume+/−, Channel+/− through a capability negotiation procedure, as shown in an example of FIG. 17, it is necessary for the controller device to display a user interface 1710 including a power button 1712 for turning on/off the controlling device, a volume control button 1714/1716 for volume up/down of the controlling device, a channel control button 1718/1719 for channel up/down of the controlling device and the like. The controller device can transmit an appropriate command to the controlling device based on a touch input touching a specific button on the user interface 1710.

The controller device may configure a user interface by itself or may receive user interface information from the controlling device to configure a user interface. To this end, the controller device can check whether or not the controlling device is equipped with capability capable of providing UI information via a service discovery procedure or a capability negotiation procedure with the controlling device.

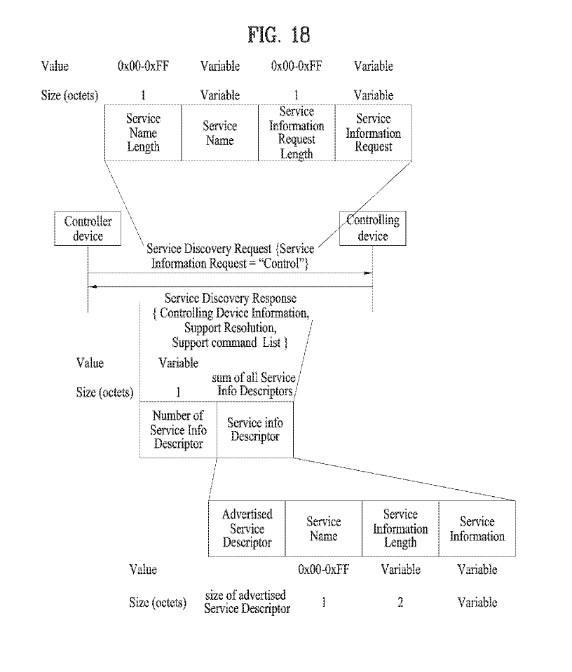

FIG. 18 is a diagram for a service discovery procedure between a controller device and a controlling device.

If a device discovery procedure is completed, a controller device can transmit a service discovery request frame to a controlling device. In this case, a service information request parameter can be included in the service discovery request frame. The service information request parameter can include a text string of a service for which the controller device intends to search.

As an example, if a value of the service information request parameter is set to ‘Control’, the controller device can make a request for a list of all static information of the controlling device while a service discovery procedure is performed. If the value of the service information request parameter is set to ‘Null’, the controller device does not make a request for the static information of the controlling device while the service discovery procedure is performed.

The controlling device can transmit a service discovery response frame including service information to the controller device in response to the service discovery request frame. In this case, if a value of the service information request parameter is set to ‘Control’, the service information can include device information of the controlling device, UI resolution supported by the controlling device, a list of commands capable of being remotely controlled in the controlling device (or a list of commands supported through UI) and the like.

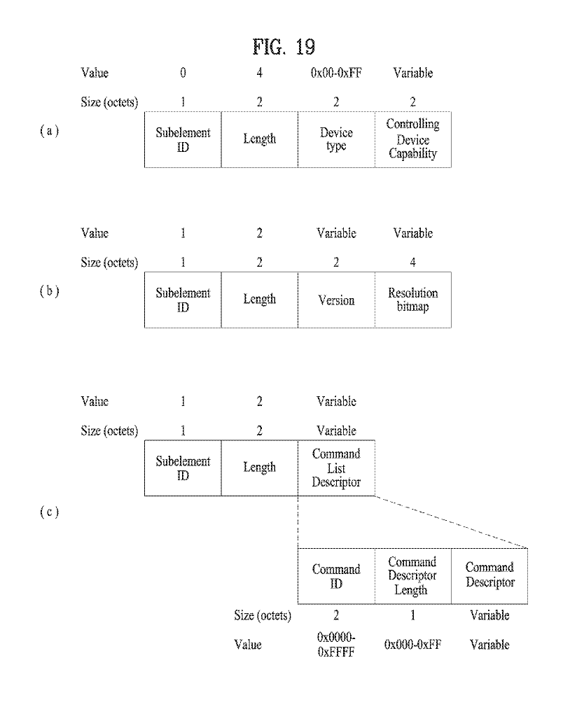

FIG. 19 is a diagram for a structure of information elements included in service information. Referring to FIG. 19, a service discovery response frame can include at least one or more information elements (IEs). In this case, each of the information elements can include a subelement ID field and a length field. The subelement ID field is used for identifying a corresponding information element and the length field indicates length of fields appeared after the subelement ID field.

As an example, as shown in FIG. 19 (a), if a value of the subelement ID field corresponds to 0, it may indicate that a corresponding information element corresponds to an information element including capability of a controlling device. As shown in FIG. 19 (b), if a value of the subelement ID field corresponds to 1, it may indicate that a corresponding information element corresponds to an information element including resolution capable of supporting UI information. As shown in FIG. 19 (c), if a value of the subelement ID field corresponds to 2, it may indicate that a corresponding information element corresponds to an information element including a list of commands supported by the controlling device.

An information element for transmitting capability of the controlling device can further include a device type field and a controller device capability field.

The device type field indicates whether a type of the controlling device corresponds to a main device type or a sub device type.

The controller device capability field may correspond to capability of the controlling device represented by a bitmap form. The controlling device can indicate capability of the controlling device through each bit of the controller device capability field.

As an example, Table 3 in the following shows capability of the controlling device according to a value of each bit of the controller device capability field.

TABLE 3

| Bits | Name | Value: Interpretation |
|---|---|---|
| 0 | Device Type | 0b0: Controlling Device Only |
| | | 0b1: Dual role device for Controlling device |
| | | and Controller device |
| 3:1 | Support | 0b000: Wi-Fi Direct |
| | Connectivity | 0b010: Wi-Fi Infrastructure mode |
| | | 0b100: NAN |
| 4 | UI | 0b0: Controlling Device is not support UI |
| | Information | information transmission |
| | Transmission | 0b1: Controlling Device is able to transmit |
| | | its UI information to controller device |
| 5 | Wi-Fi | 0b0: Wi-Fi Wake-On functionality is not |
| | Wake-On | supported |
| | capability | 0b1: Wi-Fi Wake-On functionality is |
| | | supported |
| 6 | Monitoring | 0b0: Wi-Fi Monitoring functionality is not |
| | Capability | supported |
| | | 0b1: Wi-Fi Monitoring functionality is supported |
| 7 | Persistent | 0b0: Controlling device is not able to support |
| | Connection | persistent connection functionality |
| | | 0b1: Controlling device is able to support |
| | | persistent connection functionality |
| 15:8 | Reserved | |

As shown in Table 3, the controlling device can transmit information on a device type, supported connectivity, UI information transmission capability, wake-on capability through Wi-Fi, monitoring capability, and persistent connection capability.

The device type information can indicate whether the controlling device operates as a controlling device only or operates as a dual-role device.

The information on the supported connectivity can indicate whether or not the controlling device supports Wi-Fi Direct, a Wi-Fi infrastructure mode, a NAN (neighborhood area network) and the like.

The information on the UI information transmission capability can indicate whether or not the controlling device supports UI transmission to the controller device.

The information on the wake-on capability through Wi-Fi can indicate whether or not the controlling device supports a function woke-on through Wi-Fi.

The information on the monitoring capability can indicate whether the controlling device supports a Wi-Fi monitoring function.

The information on the persistent connection capability can indicate whether the controlling device supports a persistent connection function.

In the controller device capability field, if the controlling device is configured to be equipped with UI information transmission capability, the service discovery response frame can further include an information element including resolution capable of supporting UI information. The controlling device can inform the controller device of resolution of UI information capable of being supported to the controller device.

The information element for transmitting the resolution capable of supporting the UI information can further include a version field and a resolution bitmap filed besides the subelement ID field and the length field.

The version field can indicate a version of UI information. The version field may have a size of minimum 2 octets. In this case, one byte indicates a High version and another byte may indicate a Low version. For example, if the UI information corresponds to 2.1, one byte indicates ‘2’ corresponding to the High version and another byte may indicate ‘1’ corresponding to the Low version.

The resolution bitmap field may indicate resolution capable of supporting UI information. Specifically, the controlling device can indicate whether the UI information is able to support specific resolution through each bit of the resolution bitmap field.

As an example, Table 4 in the following shows resolution capable of being supported by UI information according to each bit of the resolution bitmap field.

TABLE 4

| Bit | Resolution |
|---|---|
| b0 | 320 × 240 |
| b1 | 480 × 272 |
| b2 | 512 × 342 |
| b3 | 640 × 360 |
| b4 | 640 × 400 |
| b5 | 720 × 480 |
| b6 | 640 × 480 |
| b7 | 800 × 480 |
| b8 | 854 × 480 |
| b9 | 848 × 480 |
| b10 | 864 × 480 |
| b11 | 960 × 540 |
| b12 | 800 × 600 |
| b13 | 832 × 624 |
| b14 | 1024 × 768 |
| b15 | 1360 × 768 |
| b16 | 1600 × 900 |
| b17 | 1280 × 1024 |
| b18 | 1400 × 1050 |
| b19 | 1680 × 1050 |
| b20 | 1920 × 1080 |
| b21 | 2048 × 1080 |
| b22 | 4096 × 2160 |
| b23 | 7680 × 4320 |
| b24-31 | Reserved |

For example, if resolution capable of being supported by UI information corresponds to 800×600 and 1280×1024 only, b12 bit and b17 bit in the resolution bitmap field may take ‘true’ (1′) value while the remaining bits take ‘false’ (‘0’).

A service discovery frame can include a list of commands capable of being remotely controlled by the controller device. An information element for transmitting the list of commands can further include a command list descriptor field as well as the subelement ID field and the length field.

The command list descriptor field can further include a command ID field, a command description length field and a command description field. The command ID field indicates a representative identifier of a command among commands capable of being remotely controlled in the controlling device. A command identifier can be used for distinguishing one command from another command.

The command description length field can indicate a length of a command description field appearing after the command description length field. Maximum 256 characters can be inserted into the command description field.

A character for briefly explaining a command can be inserted into the command description field.

As an example, a Volume Up command and a Volume Down command can be indicated as follows in the command list descriptor field.

Command ID: 0x0011, Command Descriptor: volume up

Command ID: 0x0012, Command Descriptor: volume down

In the aforementioned example, it is explained as the controller device is able to check capability of the controlling device through the service discovery procedure. As a different example, the controller device can also check whether or not the controlling device is equipped with capability capable of providing a user interface through a capability negotiation procedure.

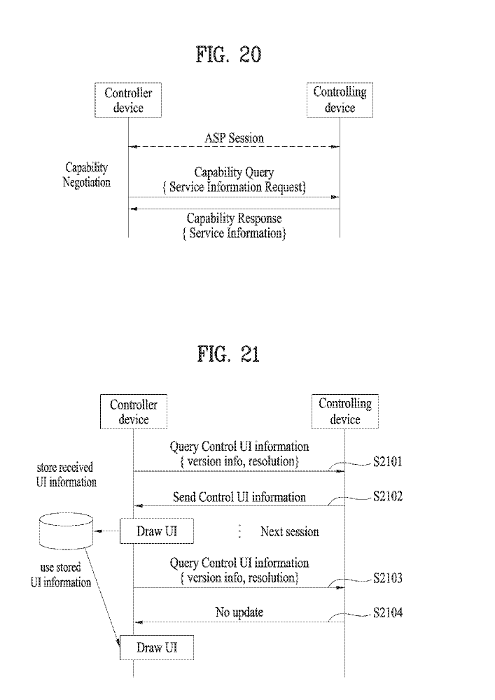

FIG. 20 is a diagram for a capability negotiation procedure between a controller device and a controlling device.

If an ASP session is connected and IP connection is established between a controller device and a controlling device, the controller device and the controlling device can perform a capability negotiation procedure through an IP packet in the ASP session.

Specifically, the controller device transmits a capability query frame to the controlling device and the controlling device can transmit a capability response frame to the controller device in response to the capability query frame.

In this case, the capability response frame can include information on the controlling device, UI resolution supported by the controlling device, a list of functions capable of being remotely controlled in the controlling device (or a list of commands supported in UI) and the like. Since an information element including the information on the controlling device, an information element including UI resolution, and an information element including the list of functions capable of being remotely controlled in the controlling device are mentioned earlier with reference to FIG. 19, detail explanation on the information elements is omitted at this time.

If it is determined as the controlling device is equipped with capability capable of transmitting UI information, the controller device may ask the controlling device to transmit the UI information. Specifically, the controller device asks the controlling device to transmit UI information suitable for resolution of a display unit of the controller device and the controlling device can transmit the UI information to the controller device in response to the request of the controller device.

FIG. 21 is a flowchart for an example of transmitting UI information. If a controller device stores UI information in advance, the controller device can transmit a UI information query frame including version information of the previously stored UI information and resolution information of a display unit [S2101, S2103].

If no UI information is stored in the controller device, the version information can be set to “Null”.

The controlling device can transmit the UI information to the controller device in response to the request of the controller device [S2102]. In this case, if the UI information stored in the controller device in advance is not updated anymore (i.e., if the controlling device stores UI information of a version identical (or lower version) to a version of the UI information stored in the controller device), the controlling device can transmit information indicating that update is not achieved to the controller device instead of the UI information [S2104]. In this case, the controller device may configure UI using the UI information stored in advance.

The UI information may correspond to an image representing a user interface, which is capable of being outputted in the controller device, or a partial image constructing a user interface such as a button associated with a specific command, an icon and the like.

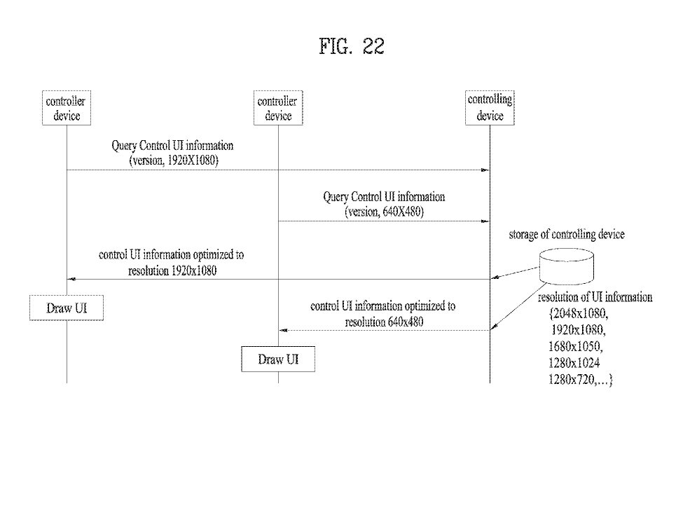

The controlling device can transmit UI information suitable for resolution of the controller device. As an example, FIG. 22 is a diagram for an example of transmitting UI information appropriate for resolution of the controller device. For clarity, assume that connections are established between the controlling device and two controller devices.

If display resolution of one controller device corresponds to 1920×1080, the controlling device can provide the controller device with UI information of which resolution corresponds to 1920×1080.

If display resolution of another controller device corresponds to 640×480, the controlling device can provide the controller device with UI information of which resolution corresponds to 640×480.

If UI information identical to display resolution of the controller device is not stored in the controlling device, the controlling device may provide the controller device with UI information of resolution made of an aspect ratio identical (or most similar) to the display resolution of the controller device. In this case, the controller device can output the UI information in a manner of resizing the UI information in accordance with the display resolution of the controller device.

FIG. 21 shows an example that the controlling device checks necessity of updating a user interface stored in the controller device in advance based on the version information included in the UI information query frame.

As a different example, the controller device can check necessity of updating a user interface in a manner of checking a version of a user interface stored in the controlling device in advance.

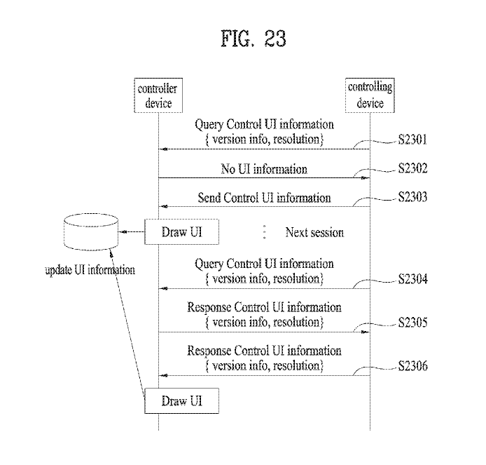

As an example, FIG. 23 is a flowchart for a different example of updating UI information. If it is necessary to update a user interface, a controlling device can transmit a UI information query frame to a controller device to make a request for a version of UI information and resolution stored in the controller device [S2301, S2304].

In this case, if there is no UI information stored in the controller device in advance, the controller device can transmit information indicating that there is no UI information stored in the controller device to the controlling device [S2302]. Subsequently, the controlling device can transmit UI information to the controller device [S2303].

If UI information stored in the controller device exists, the controller device can transmit a version of the stored UI information and resolution information to the controlling device [S2305]. If the version of the UI information stored in the controller device corresponds to a lower version, the controlling device can transmit updated UI information to the controller device [S2306].

Having received the UI information, the controller device can configure a user interface based on the received UI information. For details, it may refer to FIG. 23.

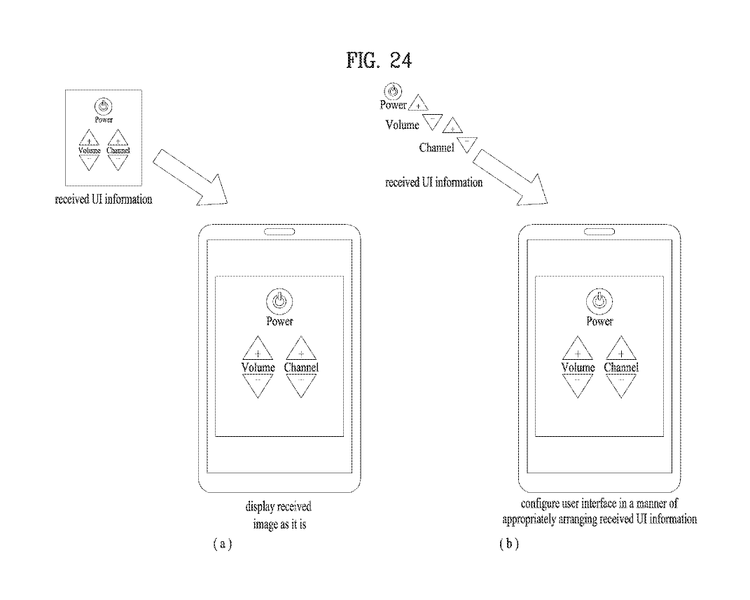

FIG. 24 is a diagram of an example for a controller device to configure a UI based on received UI information.

If an image representing a user interface is received from a controlling device, as shown in an example of FIG. 24 (a), a controller device can display the received image as a user interface.

On the contrary, if at least one or more objects such as buttons, icons, texts and the like for triggering a specific command are received from the controlling device, as shown in an example of FIG. 24 (b), the controller device can control a user interface at which the received objects are appropriately arranged to be displayed.

The UI information can further include sound data. If a specific button is selected on the user interface, the sound data can be outputted as a feedback to indicate that the button is selected.

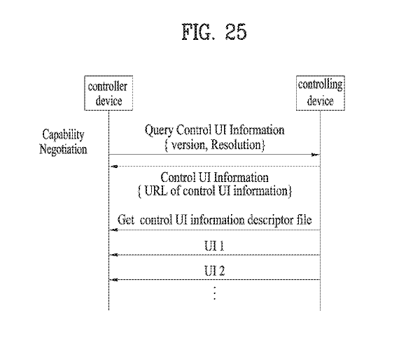

FIG. 25 is a diagram for a different example of transmitting UI information. If a transmission request for UI information is received from a controller device, a controlling device can transmit a description file (e.g., a file of XML form) including URL address from which UI information is received to the controller device. Then, the controller device can receive the UI information from the controlling device through the URL address.

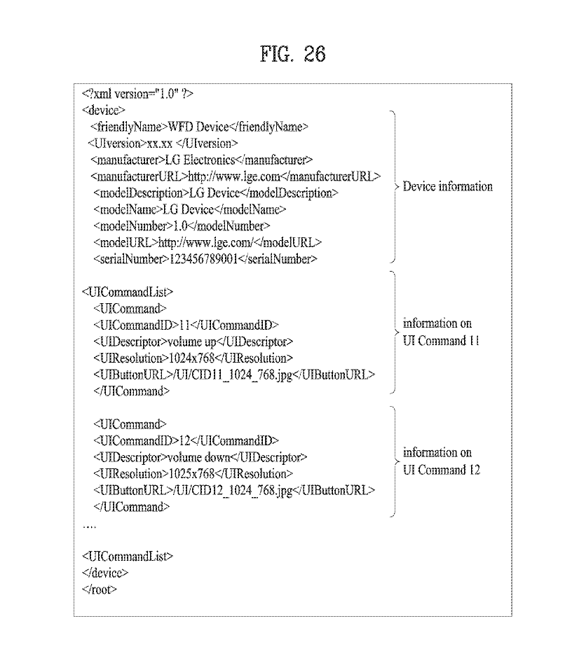

FIG. 26 is a diagram for an example of a descriptor file (UI transmission descriptor) for transmitting UI information. As shown in the example of FIG. 26, the descriptor file can include device information and information on a list of UI commands.

Referring to the example of FIG. 26, the device information includes a name (FriendlyName) of a controlling device displayed on a controller device, version information of a UI stored in the controlling device, a manufacturer of a device, a model name (modelName) of the device, a serial number (serialNumber) of the device and the like.

Referring to the example of FIG. 26, the list of UI commands includes an identifier (UICommandID) of a command capable of being remotely received from the controller device by the controlling device, a description on a command (UI Descriptor), resolution (UIResolution) and a URL (UIButtonURL) capable of accessing an object (e.g., a button or an icon) mapped to a command.

As an example, in the example shown in FIG. 26, a Volume Up command (UI Descriptor) can be identified by a command ID ‘11’ and a button for triggering the Volume Up command can be received in a manner of accessing ‘/UI/CID11_1024.768.jpg’ (UIButtonURL). Moreover, it is able to consider as resolution of the button is optimized for 1024×768 (UIResolution).

A Volume Down command (UI Descriptor) can be identified by a command ID ‘12’ and a button for triggering the Volume Down command can be received in a manner of accessing ‘/UI/CID12_1024.768.jpg’ (UIButtonURL). Moreover, it is able to consider as resolution of the button is optimized for 1024×768 (UIResolution).

According to the example of FIG. 26, a URL address capable of accessing an object matched with a prescribed command is included in a descriptor file. In this case, it is not mandatory that the object (e.g., a button, an icon, a text or the like) is mapped to the prescribed command. The descriptor file may include a URL address to access the object and identification information of the object.

As a different example, a descriptor file may include resolution of an image representing a UI and a URL address capable of accessing all images of the UI. In this case, the controller device receives the image representing the UI by accessing the URL address and may be able to display the received image.

The controller device can configure a user interface based on received UI information. As an example, if the controller device receives 5 button images corresponding to Power On/Off, Volume Up, Volume Down, Channel Up, and Channel Down, respectively, from the controlling device, as mentioned earlier with reference to FIG. 24 (b), the controller device can control a user interface consisting of the 5 buttons to be outputted.

If a user input for selecting a specific object on a user interface is received, the controller device can transmit an identifier of a command corresponding to the selected object to the controlling device.

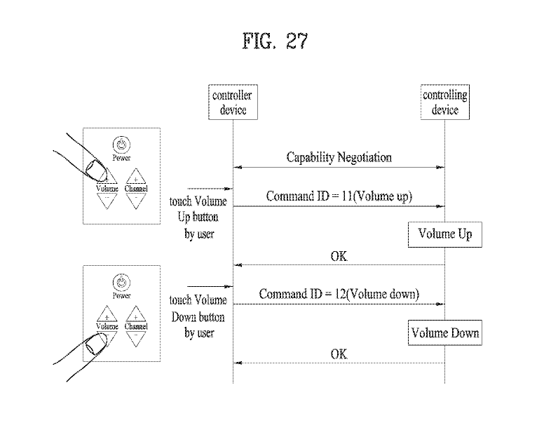

As an example, FIG. 27 is a diagram for an example of transmitting an identifier of a command corresponding to a selected object to a controlling device according to selection of a specific object.

If a volume up button is selected, as shown in an example of FIG. 27, the controller device can transmit an identifier ‘11’ of a volume up command to the controlling device.

The controlling device processes a command corresponding to the identifier ‘11’ (i.e., increase volume) and may be then able to transmit a result of the process to the controller device.

If a volume down button is selected, as shown in the example of FIG. 27, the controller device can transmit an identifier ‘12’ of a volume down command to the controlling device.

The controlling device processes a command corresponding to the identifier ‘12’ (i.e., decrease volume) and may be then able to transmit a result of the process to the controller device.

As a different example, if a user input for selecting a specific button on a user interface is received, the controller device can transmit an identifier of the selected button to the controlling device.

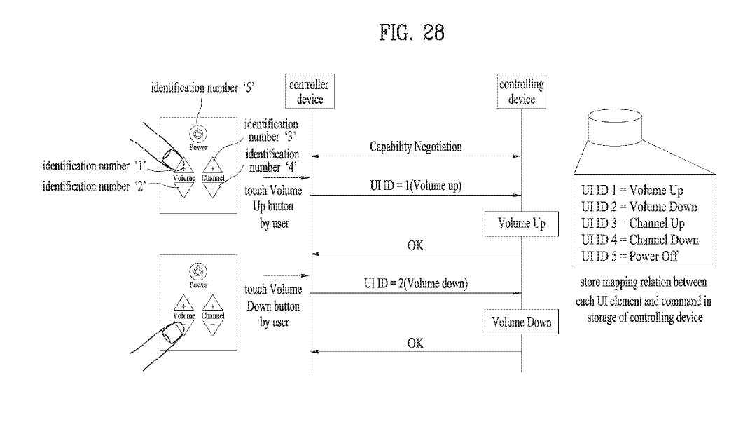

As an example, FIG. 28 is a diagram for an example of transmitting an identifier of a selected object to a controlling device according to selection of a specific object. For clarity, assume a state that a controller device receives 4 texts including ‘Volume Up’ (identification number 1), ‘Volume Down’ (identification number 2), ‘Channel Up’ (identification number 3) and ‘Channel Down’ (identification number 4) from a controlling device and configures a user interface based on the 4 texts.

If the ‘Volume Up’ text is selected, as shown in an example of FIG. 28, the controller device can transmit the identification number ‘1’ of the ‘Volume Up’ text to the controlling device.

The controlling device extracts a command corresponding to the identification number ‘1’ and may be then able to process the extracted command (i.e., increase volume). Subsequently, the controlling device can transmit a process result of the command to the controller device.

If the ‘Volume Down’ text is selected, as shown in the example of FIG. 28, the controller device can transmit the identification number ‘2’ of the ‘Volume Down’ text to the controlling device.

The controlling device extracts a command corresponding to the identification number ‘2’ and may be then able to process the extracted command (i.e., decrease volume). Subsequently, the controlling device can transmit a process result of the command to the controller device.

As mentioned in the foregoing description, if identification information of a specific object is received from the controller device, the controlling device extracts a command corresponding to the identification information and may be then able to process the extracted command. To this end, it is necessary to store identification information of an object and a mapping relation of a command in the controlling device.

If the controller device receives an image representing a user interface from the controlling device, as mentioned earlier in FIG. 24, the controller can output the received image as a user interface. If a touch input is received on the user interface, the controller device can transmit information on a coordinate at which the touch input of a user is received on the user interface to the controlling device.

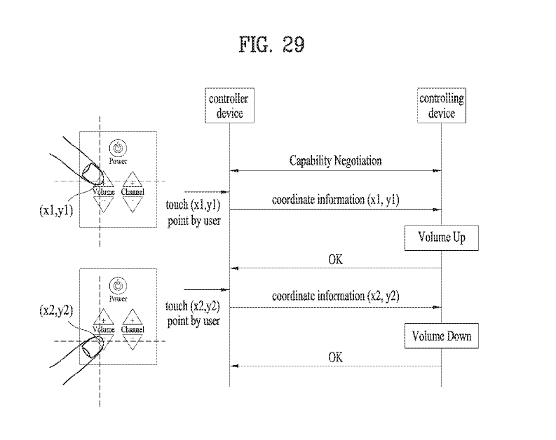

As an example, FIG. 29 is a diagram for an example of transmitting information on a coordinate on which a touch input is received to a controlling device according to the touch input received on a user interface.

If a coordinate of a user interface on which a touch input is received corresponds to (x1,y1), as shown in an example of FIG. 29, the controller device can transmit information on the coordinate at which the touch input is received to the controlling device.

The controlling device extracts a command corresponding to the coordinate (x1,y1) on an image representing a user interface and may be then able to process the extracted command. As an example, if the command corresponding to the coordinate (x1,y1) on the image representing the user interface corresponds to Volume Up, the controlling device can process a command for increasing volume. Subsequently, the controlling device can transmit a process result to the controller device.

If a coordinate of a user interface on which a touch input is received corresponds to (x2,y2), as shown in the example of FIG. 29, the controller device can transmit information on the coordinate at which the touch input is received to the controlling device.

The controlling device extracts a command corresponding to the coordinate (x2,y2) on an image representing a user interface and may be then able to process the extracted command. As an example, if the command corresponding to the coordinate (x2,y2) on the image representing the user interface corresponds to Volume Down, the controlling device can process a command for decreasing volume. Subsequently, the controlling device can transmit a process result to the controller device.

As mentioned in the foregoing description, if information on a coordinate at which a touch input is received is received from the controller device, the controlling device extracts a command corresponding to the coordinate information and may be then able to process the extracted command. To this end, it is necessary to store a mapping relation between an image command representing a user interface and a region to which the image command is mapped in advance.

Turning on Controlling Device

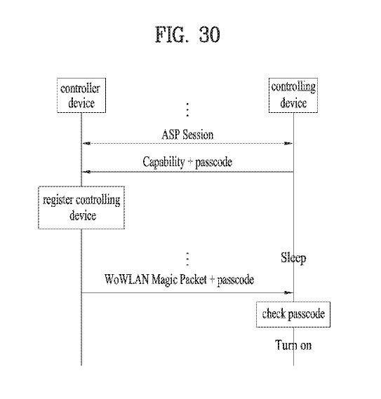

A controlling device can be remotely turned on by a controller device. Regarding this, it shall be explained in detail in the following with reference to FIG. 30.

FIG. 30 is a diagram for explaining an example of remotely turning on a controlling device by a controller device.

After an ASP session is established between a controller device and a controlling device, the controller device can check whether or not the controlling device is equipped with capability capable of being remotely turned on through a service discovery procedure or a capability negotiation procedure.

As an example, if the controller device queries capability of the controlling device, the controlling device can respond to the query to indicate whether or not the controlling device is equipped with the capability capable of being remotely turned on. As an example, the controlling device can inform the controller device that the controlling device is equipped with the capability capable of being remotely turned on through a Wi-Fi wake on capability bit of the controlling device within a controller device capability field mentioned earlier in Table 3.

If the controlling device is equipped with the capability capable of being remotely turned on, the controlling device can further transmit a passcode to the controller device. The passcode can be inserted into a service discovery frame or a capability response frame as an information element, by which the present invention may be non-limited.

If it is checked that the controlling device is equipped with the capability capable of being remotely turned on, the controller device can register the controlling device. Specifically, the controller device can register a name (device name) of the controlling device, an address (e.g., MAC address) of the controlling device and a passcode at a storage of the controller device.

Subsequently, if the controlling device is switched to a sleep state and a user input for waking on the controlling device is received, the controller device can transmit a request data for waking up the controlling device and a passcode to the controlling device. In this case, the request data for waking up the controlling device may correspond to WoWLAN (Wake on Wireless LAN), by which the present invention may be non-limited.

Having received the request data and the passcode from the controller device, the controlling device can check whether or not the passcode transmitted by the controller device is a proper passcode. If the passcode received from the controller device corresponds to a proper passcode, the controlling device can be turned on in response to the request data.

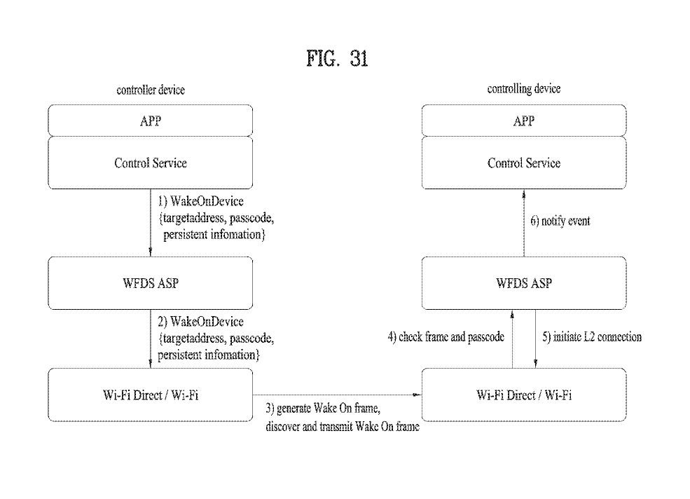

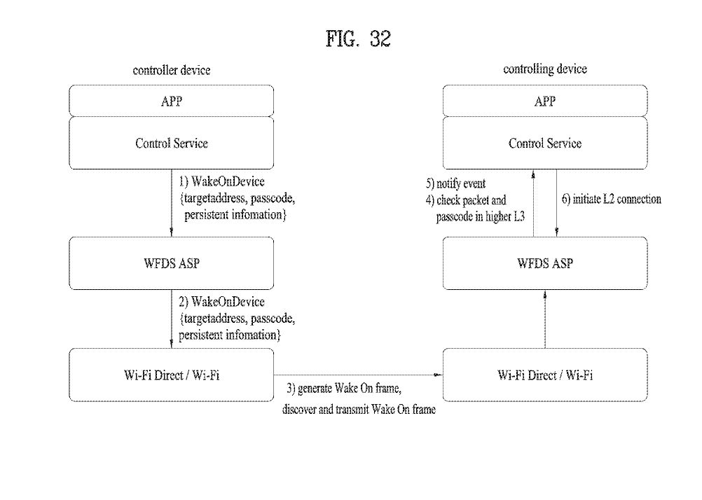

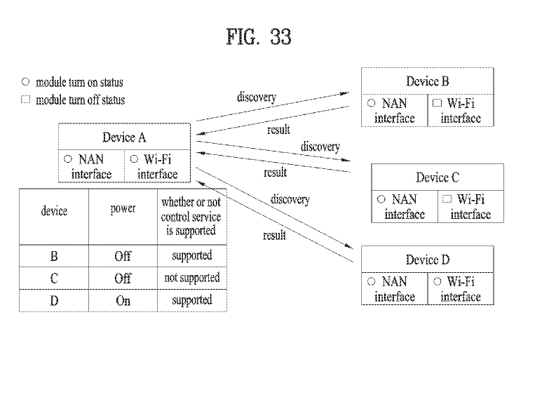

FIGS. 31 and 32 are diagrams for an API (application program interface) between a controller device and a controlling device used for turning on the controlling device by the controller device. If a user input for turning on a controlling device is received from an application layer of a controller device, a control service layer can transmit a method including information of a wake on device, which includes an address (targetaddress) (e.g., MAC address of the controlling device) of a target to be turned on, a passcode and persistent information, to an ASP. If the method including the information of the wake on device is received, the ASP of the controller device can transmit the information of the wake on device including the address (e.g., MAC address of the controlling device) of the target of the target to be woke on, the passcode and the persistent information to Wi-Fi Direct or Wi-Fi layer.

Subsequently, the Wi-Fi Direct or the Wi-Fi layer of the controller device generates a wake on frame to wake on the controlling device and may be then able to transmit the generated wake on frame to the controlling device. In this case, the wake on frame can include a passcode.

If the wake on frame is received through the Wi-Fi Direct or the Wi-Fi layer, the ASP layer of the controlling device can check the wake on frame and the passcode.

If the passcode is valid, the ASP layer of the controlling device initiates L2 connection through the Wi-Fi Direct or the Wi-Fi layer and can inform the control service layer of occurrence of an event. If the L2 connection is initiated, the controller device can remotely control the controlling device continuously after the controlling device is woke on.

If an event is received, the control service layer of the controlling device can control the controlling device to be woke on.

As a different example, the ASP layer of the controlling device can control a packet and a passcode to be checked on an L3 (layer 3). After the passcode is checked, the ASP layer can inform the service layer of occurrence of an event.

If the event is received, the control service layer of the controlling device wakes on the controlling device and may be then able to ask the ASP layer to initiate L2 connection.

A WoWLAN Magic Packet is defined as an IP packet and can be transmitted through Ethernet only. In particular, in case of turning on the sleeping controlling device using the WoWLAN Magic Packet, the controlling device has the burden of turning on a Wi-Fi communication module for Wi-Fi or Wi-Fi Direct communication in the sleep state to receive the WoWLAN Magic Packet.

Hence, the present invention intends to discuss on a method of performing a wake on procedure before the controller device and the controlling device are associated with each other (pre-association). To this end, assume that a NAN (Neighborhood Awareness Networking) module capable of operating with low power is mounted on the controller device and the controlling device. If the controlling device is turned off, assume that a Wi-Fi module maintains an off state and the NAN maintains an on state.

The controller device can check whether or not main power of the controlling device is turned on through NAN discovery.

As an example, FIG. 33 is a diagram for an example of checking whether or not a controlling device is turned on by a controller device via NAN discovery.

The controller device can check the controlling device in response to the NAN discovery. As an example, if the controller device broadcasts a discovery frame to perform the NAN discovery, devices, which has listened to the discovery frame, can respond to the discovery frame. In this case, a response frame transmitted by the devices can include information on whether or not a control service is supported and information on a turn on state of a Wi-Fi module. In this case, the information on whether or not the control service is supported can include information on whether or not the controller device is able to remotely turn on the controlling device.

If the response frame is received, the controller device can determine whether or not the controlling device is in the turn on state based on whether or not a Wi-Fi module of each controlling device is turned on. In particular, if the Wi-Fi module of the controlling device is turned on, the controller device can determine it as the controlling device is also turned on. If the Wi-Fi module of the controlling device is turned off, the controller device can determine it as the controlling device is also turned off. As an example, in FIG. 33, since a Wi-Fi interface of a device B and a Wi-Fi interface of a device C correspond to off state and a Wi-Fi interface of a device D corresponds to on state, a device A can determine it as both the device B and the device C are in turn off state and the device D is in turn on state.

If the controlling device is equipped with capability capable of being remotely turned on by the controller device, the controller device can remotely turn on the controlling device. As an example, in FIG. 33, since the device B is equipped with capability capable of being remotely turned on by the controller device and the device B is currently turned off, the device B can be turned on by the device A. On the contrary, although the device C is currently turned off, since the device C is not equipped with capability capable of being remotely turned on by the controller device, the device C is unable to be turned on by the device A. Since the device D is currently turned on, the device D is not in a state of being remotely turned on by the controller device.

In order to turn on the controlling device, the ASP of the controller device can generate a wake on packet newly defined on a layer 2. The wake on packet may have a form of a MAC frame. In this case, the wake on packet can also be referred to as a wake on MAC frame. The wake on MAC frame may correspond to an action frame, by which the present invention may be non-limited.

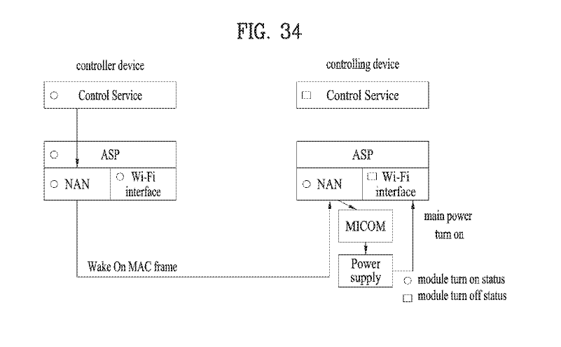

FIG. 34 is a diagram for an example of remotely turning on a controlling device by a controller device. If a user input for waking on the controlling device is received, a service layer of the controller device can deliver a wake on method to the ASP. Subsequently, the ASP of the controller device generates a wake on MAC frame and may be then able to transmit the generated wake on MAC frame to the controlling device through NAN.

If the wake on MAC frame is received, the controlling device can turn on power of the controlling device. Specifically, the controlling device can turn on the power of the controlling device through such a low-power processor as micom.

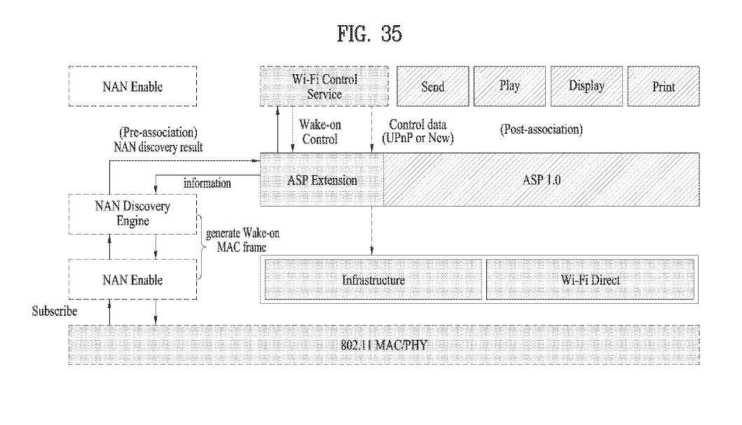

FIG. 35 is a diagram for architecture of a controller device for remotely turning on a controlling device.

Before the controller device and the controlling device are associated with each other (pre-association), the ASP of the controller device receives a NAN discovery result from a NAN discovery engine and may be able to transmit the received NAN discovery result event to a control service layer.

The control service layer can check whether or not the controlling device is equipped with capability (e.g., wake-on LAN capability) capable of being remotely turned on and whether or not the controlling device is in a state of being turned off based on the NAN discovery result.

Subsequently, if a user input for turning on the controlling device is received, the control service layer can transmit a wake-on control method to the ASP.

Having received the wake-on control method from the control service layer, the ASP layer can deliver information (e.g., MAC address of the controlling device) on the controlling device to the NAN discovery engine. The NAN discovery engine generates a wake on MAC frame based on the information on the controlling device and may be able to transmit the generated wake on MAC frame to the controlling device through NAN MAC. If the wake on MAC frame is transmitted to the controlling device via a physical layer (e.g., 802.11 MAC/PHY), the controlling device can be turned on.

Subsequently, if the controller device and the controlling device are associated with each other (post-association), the control service layer and the ASP layer can remotely control the controlling device.

Use Case

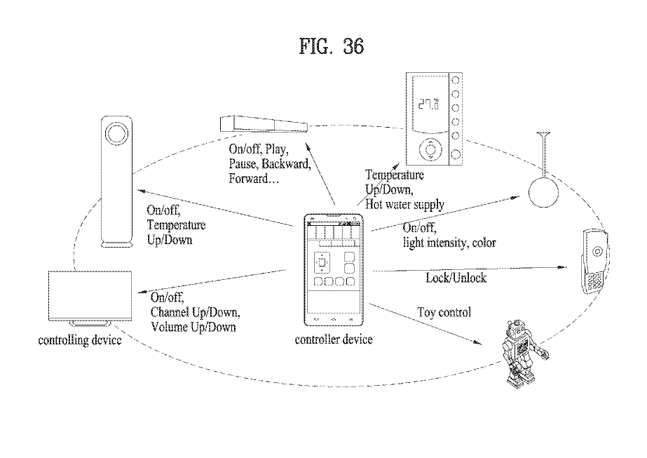

According to the aforementioned control service, it is able to remotely control a device capable of performing Wi-Fi communication through a wireless device capable of performing Wi-Fi communication. As an example, as shown in an example of FIG. 36, a user can remotely control various controlling devices such as a TV, an air conditioner, a DVD player, a boiler, a lighting device, a door, a toy and the like through a mobile terminal operating as a controller device.

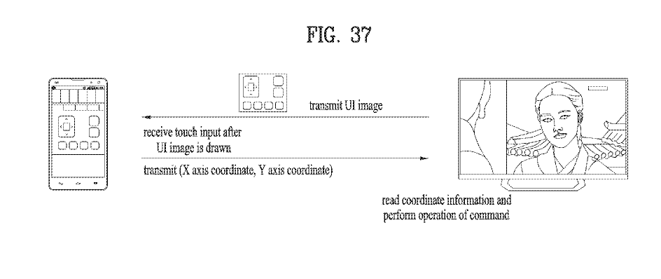

More specifically, as shown in an example of FIG. 37, if a TV provides a user interface image to a mobile terminal, a user can remotely control the TV through the user interface image.

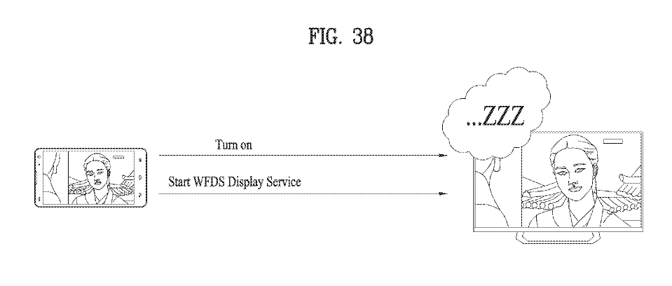

As shown in an example of FIG. 38, a user can turn on a TV through a mobile terminal. If the TV is turned on and a WFDS display service is initiated between the mobile terminal and the TV, output of the mobile terminal can be mirrored in the TV.

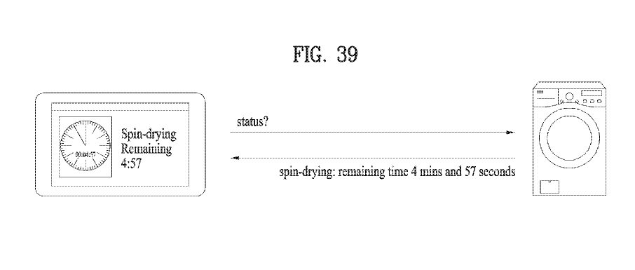

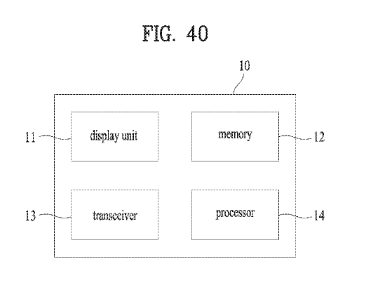

As shown in an example of FIG. 39, a user may be able to check status information of a washing machine through a mobile terminal. Hence, the user can check the status information (e.g., information on time remained until washing is completed) of the washing machine by operating the mobile terminal only without going close to the washing machine.

FIG. 40 is a block diagram for a configuration of a wireless device according one embodiment of the present invention.

A wireless device 10 can include a display unit 11, a memory 12, a transceiver 13 and a processor 14. The transceiver 13 can transmit and receive a radio signal. For example, the transceiver can implement a physical layer according to IEEE 802 system.

The display unit 11 plays role in outputting information. A controller device can output a user interface for remotely controlling a controlling device through the display unit 11.

The processor 15 is electrically connected with the transceiver 13 and may be able to implement a physical layer and/or a MAC layer according to IEEE 802 system. And, the processor 11 can be configured to perform operations of encoding and decoding data for a control service.

A module for implementing an operation of a wireless device according to the aforementioned various embodiments of the present invention is stored in the memory 12 and can be executed by the processor 15. The memory 12 can be connected with the processor 11 by a means well-known to public in a manner of being included in the inside of the processor 15 or being installed at the outside of the processor 15. Although it is not depicted, the wireless device 10 can further include a sound output unit for outputting sound.

A concreate configuration of the wireless device 10 shown in FIG. 36 can be implemented in a manner of independently applying the items mentioned earlier in the various embodiments of the present invention or applying two or more embodiments at the same time. For clarity, explanation on overlapped contents is omitted.

The embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

Although the aforementioned various embodiments of the present invention are explained centering on a Wi-Fi Direct system, the embodiments can also be applied to various mobile communication systems in a same way.

1. A method of performing a control service performed by a first wireless device to remotely control a second device, the method comprising:
discovering the second wireless device by the first wireless device;
receiving command information supported by the second wireless device from the second wireless device by the first wireless device when the second wireless device is discovered;
transmitting command identification information for identifying a command, which is to be processed by the second wireless device, to the second wireless device by the first wireless device; and
receiving a feedback on a process result of the command from the second wireless device.

2. The method of claim 1, wherein the second wireless device discovering step comprising:
transmitting a probe request frame by the first wireless device; and
receiving a probe response frame from the second wireless device in response to the probe request frame.

3. The method of claim 2, wherein the probe request frame comprises a hash value from which a first service name intended to be discovered is converted and wherein the probe response frame comprises a second service name matched with the hash value.

4. The method of claim 3, wherein the first service name comprises information for identifying whether or not the first wireless device corresponds to a controller device capable of remotely controlling another device.

5. The method of claim 3, wherein the second service name comprises at least one of information for identifying whether or not the second wireless device corresponds to a controlling device capable of being remotely controlled by another device and information for identifying a category to which the second wireless device belongs thereto.

6. The method of claim 1, wherein the command information comprises at least one of identification information for identifying a command supported by the second wireless device and address information for accessing an object mapped to the identification information.

7. The method of claim 6, further comprising the step of displaying a user interface which is generated by the first wireless device based on the object,
wherein the command identification information corresponds to identification information of a command mapped to an object, which is selected from the user interface by a user.

8. The method of claim 6, wherein the object comprises at least one selected from the group consisting of a text to which the identification information is mapped, a button image and an icon image.

9. The method of claim 1, wherein the command information comprises at least one of address information for accessing an object and identification information of the object.

10. The method of claim 9, further comprising the step of displaying a user interface which is generated by the first wireless device based on the object,
wherein the command identification information comprises identification information of an object selected from the user interface by a user.

11. The method of claim 1, wherein the command information comprises address information for accessing a prescribed image in the first wireless device.

12. The method of claim 11, further comprising the step of displaying the prescribed image displayed by the first wireless device,
wherein the command identification information comprises information on a coordinate touched by a user in the prescribed image.

13. The method of claim 12, wherein if resolution of the prescribed image is different from display resolution of the first wireless device, the first wireless device displays the prescribed image in a manner of resizing the prescribed image in accordance with the display resolution.

14-17. (canceled)

18. A first wireless device performing a control service, comprising:
a display unit;
a transceiver; and
a processor is configured to control the display unit and the transceiver, wherein the processor is further configured to control the transceiver to:
receive command information supported by the second wireless device from a second wireless device when the second wireless device is discovered,
transmit command identification information for identifying a command, which is to be processed by the second wireless device, to the second wireless device, and
receive a feedback on a process result of the command from the second wireless device.

19. A first wireless device performing a control service, comprising:
a transceiver; and
a processor is configured to control the transceiver to,
wherein the processor is further configured to control the transceiver to:
transmit command information supported by the first wireless device to a second wireless device when the second wireless device is discovered,
process a command corresponding to the command identification information when command identification information is received from the second wireless device, and
transmit a feedback on a process result of the command to the second wireless device.

20. A method of performing a control service capable of remotely controlling a second wireless device, which is performed by a first wireless device, the method comprising:
discovering the second wireless device through a first interface;
performing association with the discovered second wireless device, wherein if the first interface is off, discovery of the second wireless device through the first interface is performed after the first interface is turned on in a manner that the second wireless device receives a turn on message from the first wireless device through a second interface;
receiving status information of the second wireless device and capability information of the second wireless device from the second wireless device; and
if the second wireless device is in turn off status, transmitting a turn on data for turning on the second wireless device to the second wireless device.

21. The method of claim 20, wherein the first interface corresponds to a Wi-Fi interface and wherein the second interface corresponds to a NAN (Neighborhood Awareness Networking) interface.

22. The method of claim 21, wherein the second interface corresponds to an interface using power equal to or less than a referenced value only.

23. The method of claim 20, further comprising the step of receiving status information for indicating whether the first interface of the second wireless device is turned on or off and capability information indicating whether or not the second wireless device is able to be turned on by the second interface from the second wireless device.

24. The method of claim 23, wherein if the status information indicates that the first interface of the second wireless device is in off status and the capability information indicates that the second wireless device is equipped with capability capable of being turned on by the second interface, the first wireless device transmits the turn on message to the second wireless device through the second interface.
